(19) United States
(12) Patent Application Publication
(10) Pub. No.: US 2017/0198679 A1
(43) Pub. Date: Jul. 13, 2017

(54) Apparatus for Harnessing Flowing Fluids to Create Torque

(71) Applicants: Wallace Wright Kempkey, Seattle, WA (US); Robert Edward Breidenthal, Seattle, WA (US)

(72) Inventors: Wallace Wright Kempkey, Seattle, WA (US); Robert Edward Breidenthal, Seattle, WA (US)

(73) Assignee: Pterofin, LLC, Seattle, WA (US)

(21) Appl. No.: 15/472,047

(22) Filed: Mar. 28, 2017

Related U.S. Application Data
(63) Continuation-in-part of application No. 14/244,657, filed on Apr. 3, 2014.
Application No. 14/244,657 is a continuation of application No. 13/217,170, filed on Aug. 24, 2011, now abandoned.
(60) Provisional application No. 61/402,175, filed on Aug. 25, 2010.

(51) Int. Cl. F03D 5/06; F03G 3/06; F03D 9/25

(52) U.S. Cl. CPC F03D 5/06; F03D 9/25; F03G 3/06

(57) ABSTRACT

An apparatus for producing high output and low cost/time, sustainable energy from a fluid flow, such as wind or water natural currents. The apparatus has one or more wings that pivot and change their angle of attack, and oscillate with a counterbalance system that synchronizes the wings' position and speed with a mechanical leverage point on the body of the device. When a fluid flows past the wing, a pendulum causes the wing to constantly change its angle of attack such that the oscillation can harmonizing to the natural frequency of a fluid's specific velocity. The pivoting is translated into mechanical force on a shaft, which then can create torque at a generator or pump.

### CROSS-REFERENCE TO RELATED APPLICATIONS

This application is a continuation-in-part of U.S. Utility application Ser. No. 14/244,657, filed on Apr. 3, 2014, which is a continuation of U.S. Utility application Ser. No. 13/217,170, filed on Aug. 24, 2011, which claims the benefit of U.S. Provisional Application No. 61/402,175 filed on Aug. 25, 2010, the entire disclosures of which are hereby incorporated by reference herein in their entirety for all purposes.

### BACKGROUND

1. Field of the Invention

This invention relates generally to the field of harnessing the energy of moving fluids. More specifically, the present invention is related to apparatuses that can use a force of a flowing fluid, such as air or water, deflecting against components of the apparatus to generate torque.

2. Description of the Related Art

There are a number of products that provide a way of generating electricity from moving fluids, such as windmills, dams, and tidal turbines. These devices can be a much better alternative than fossil fuels, natural gas, or other biofuels. Additionally, the technology is expensive, and suffers from a number of other problems, including inefficiency and unreliability.

Currently, fluid flow force-capturing devices are generally incapable of generating power from both water and wind currents. Windmills will only function with wind, and dams and tidal turbines are restricted to an aqueous environment. This increases development, deployment, and maintenance costs for these types of devices.

Moreover, the optimization of the existing devices typically require a large surface area of the blades on the turbines, which requires lot of physical space. For example, a windmill requires enough space to allow its blades to spin freely, and must be positioned high enough to receive strong air currents. Since many regions impose height restriction ordinances, windmills have limited use in populated areas. Likewise, with respect to water powered devices, a dam requires a large valley to build up enough water pressure to spin turbines. And tidal turbines must be isolated to prevent damage to boats and swimmers.

Windmills and tidal turbines also suffer efficiency problems on the extreme levels of fluid-flow, either too low or too high. In low flows, these devices are unable to spin, so no energy can be generated. In high flows, the devices risk spinning out of control and beyond operational tolerances, and require complicated electronic pitching and braking mechanisms. If these stabilization systems fail, the device may undergo damage.

Additionally, windmills and tidal turbines can have a negative environmental impact. Both can be noisy and emit low frequency sounds that harass wildlife, such as insects or fish. Dams flood valleys, which can eliminate spawning grounds of fish that return to the same place every year, as well as other riverside macro and micro-ecosystems. Windmills can also create a strobing flicker as sunlight passes through the blades, which is known to cause seizures in humans and animals. Windmills can also kill coastal, migratory, or predatory birds and bats.

### SUMMARY OF THE INVENTION

An apparatus and method for harnessing flowing fluids is provided that can provide usable torque to power a generator or pump. In one embodiment, the apparatus includes a horizontally-aligned shaft rotatably coupled to a support structure, and oriented along and rotating about a shaft axis. At least one wing is rotatably coupled to the shaft, with the wing impacting a fluid flow that is generally parallel to the shaft axis, and the wing oriented along a wing axis that is substantially perpendicular to the shaft axis. The wing is rotatable about the shaft from a first shaft axis position to a second shaft axis position, and is also rotatable about the wing axis from a first wing axis position to a second wing axis position such that the wing presents a first angle of attack when in the first wing axis position and a second angle of attack when in the second wing axis position.

A pendulum is coupled to the lower portion of the wing and pivotable about a pendulum axis from a first pendulum position to a second pendulum position such that when the wing transitions from the first shaft axis position to the second shaft axis position, gravitational force causes the pendulum to pivot from the first pendulum position to the second pendulum position to thereby rotate the wing from the first wing axis position to the second wing axis position, thereby changing the wing from the first angle of attack to the second angle of attack until the wing returns to the first wing axis position and first shaft axis position.

Thus, upon a fluid flow impacting the wing, such as the wind or a water current, the wing is rotated between the first shaft axis position and second shaft axis position, constantly changing the angle of attack of the wing from the pivoting of the pendulum about the pendulum axis to thereby impart torque on the shaft. The wing(s) can then oscillate in an arc about the shaft axis between the first shaft axis position and second shaft axis position in a harmonic fashion with the fluid flow.

In one embodiment, the apparatus is mounted on a base that positions components partially underground. Alternatively, the device is mounted on a base similar to a typical windmill tower. The connecting point of the structure to the device may be a bearing capable of rotating the housing and wings about a vertical axis. As such, the wing(s) can be rotated into the optimal direction of fluid flow. In one implementation, the control system reorients the wing according to the speed of the fluid flow and the position of the wing in the arc to maximize efficiency and reliability.

In one embodiment, a rudder is attached to the central axis and remains fixed in position while the wings pivot. As the fluid flows past the rudder, it reorients the support structure on the base to face maximally into the fluid flow. A control system can also be present that uses a counterweight to orient the one or more wings via gravitation pull on the counterweight. Alternately, the control system can be a spring using resistance to orient the wings, or can be a fluid rudder utilizing the fluid flow to provide motive force to orient the wings.

In one embodiment, the one or more wings are each hinged at the shaft to allow the wing to fold towards the shaft in response to excessive force being applied to the wing, such as from debris in the fluid flow, high fluid flow speeds, or faulty action by the control system.

In operation, the gentle oscillation of the one or more wings mimics an animals propulsive wing action, such as a bird or insect wing as it flaps through the air, or fish fins propelling through the water. The apparatus can operate at much slower air-flow rates that traditional radial windmills, and is thus scalable and economical at smaller sizes than required for radial windmills.

### BRIEF DESCRIPTION OF THE DRAWINGS

FIG. 1 is a front-left isometric view of a device for harnessing flowing fluids, according to one or more embodiments.

FIG. 2A is a front-left isometric view of a device with wings that oscillate through an arc about a central axis,

FIG. 2B is a front-left isometric view of the device illustrated in FIG. 2A, wherein the wings have advanced in position in response to a flowing fluid

FIG. 2C is a front-right isometric view of the device illustrated in FIG. 2A.

FIG. 2D is front isometric view of the device illustrated in FIG. 2A showing different wing positions in response to a moving fluid.

FIG. 3A is a front-left isometric view of one embodiment of the device for harnessing flowing fluids.

FIG. 3B is a front-left isometric view of the device illustrated in FIG. 3A, wherein the wings have advanced position in response to a flowing fluid.

FIGS. 4A, 4B, and 4C illustrate a front view, side view, and top view respectively, of a device for harnessing flowing fluids with a neutral wing position.

FIGS. 5A, 5B, and 5C illustrate a front view, side view, and top view respectively, of the device for harnessing flowing fluids in a wing position that is midway to a maximum displacement from the neutral wing position.

FIGS. 6A, 6B, and 6C, illustrate a front view, side view, and top view respectively, of the device for harnessing flowing fluids with a wing position at a maximum displacement from the neutral wing position.

FIGS. 7 and 8 illustrate different positions of an elastic connector between the pendulum and supporting structure.

FIG. 9 illustrates one embodiment the control system of a device.

FIG. 10 illustrates a design of an extra wing or fin on the control system 128 described in FIG. 9.

FIG. 11 illustrates a hydraulic pump or pulley 502 for use with the control system 128 as described in FIG. 9.

FIG. 12 illustrates a pendulum lever arm that can be positioned in front of a counterbalance arm.

FIG. 13 illustrates one embodiment of a thinned neck of a device.

FIG. 14 further shows the counterweights of FIG. 13.

FIG. 15 illustrates one embodiment of the wings.

FIGS. 16A and 16B illustrate another embodiment of a control system for a device, such as the device shown in FIG. 1.

FIGS. 17A and 17B illustrate another embodiment of the control system for a device, such as the device shown in FIG. 1

FIGS. 18A and 18B illustrate another embodiment of a control system 128 for a device, such as the device 120 shown in FIG. 1.

FIGS. 19A and 19B illustrate a variation of a control system for a device, such as the device shown in FIGS. 18A and 18B.

FIGS. 20A and 20B illustrate another embodiment of a control system 128 for a device, such as the device 120 shown in FIG. 1.

FIGS. 21A and 21B illustrate a variation of a control system for a device, such as the device shown in FIGS. 18A and 18B.

FIGS. 22A and 22B illustrate a variation of a control system for a device, such as the device shown in FIGS. 19A and 19B.

FIGS. 23A and 23B illustrate one embodiment of a control system for a device, such as the device shown in FIG. 1.

FIGS. 24A and 24B illustrate-wings of a device that incorporate different materials.

FIGS. 25A and 25B illustrate a further rotating design of a device for harnessing flowing fluids.

FIGS. 26A and 26B illustrate one embodiment of a multi-wing rotating design of a device for harnessing flowing fluids.

FIGS. 27A and 27B illustrate one embodiment of a curved wing in a sail-shape.

FIGS. 28A and 28B illustrate one embodiment of the wing in a triangular shape.

FIGS. 29A and 29B illustrate an embodiment of a rotating design of a device for harnessing flowing fluids.

FIG. 30 illustrates a further embodiment of a rotating design of a device for harnessing flowing fluids.

FIG. 31A illustrates a cutaway view of a device showing exploded views of various internal mechanisms.

FIG. 31B illustrates a cross-sectional view through Section A-A of FIG. 31A, and depicts an arrangement of internal mechanisms.

FIG. 32A illustrates a cutaway of a device showing exploded views of various internal mechanisms.

FIG. 32B illustrates a cross-sectional view through section B-B of FIG. 32A, and depicts one embodiment of the arrangement of internal mechanisms.

FIGS. 33A and 33B illustrate one embodiment of the internal components.

FIG. 34A illustrates one embodiment of the internal components of the shaft.

FIG. 34B illustrates a view of the internal components of the shaft of the device at View A of FIG. 34A.

### DETAILED DESCRIPTION OF THE EMBODIMENTS

The Figures (FIGS.) and the following description relate to preferred embodiments by way of illustration only. It should be noted that from the following discussion, alternative embodiments of the structures and methods disclosed herein will be readily recognized as viable alternatives that may be employed without departing from the principles of what is claimed.

Reference will now be made in detail to several embodiments, examples of which are illustrated in the accompanying figures. It is noted that wherever practicable similar or like reference numbers may be used in the figures and may indicate similar or like functionality. The figures depict embodiments of the disclosed device (or method) for purposes of illustration only. One skilled in the art will readily recognize from the following description that alternative embodiments of the structures and methods illustrated herein may be employed without departing from the principles described herein.

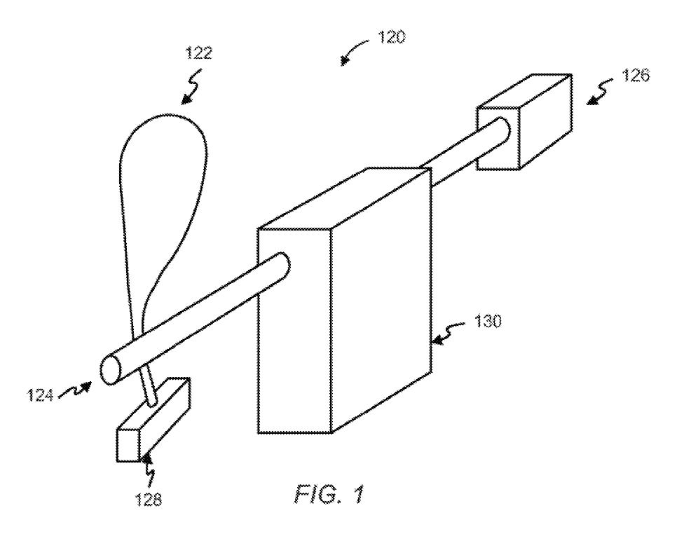

Illustrated in FIG. 1 is a front-left isometric view of a device or apparatus 120 for harnessing flowing fluids, according to one or more embodiments. The device 120 includes one or more wings 122, a shaft 124, a generator 126, a control system 128, and a base 130. When a fluid flows past the wings 122, the fluid flow induces motion in the wings, which causes the shaft 124 or a component of the shaft to move. This motion creates torque at the generator 126. For purposes of illustration, FIG. 1 shows only one wing 122, but the device 120 can include any number of wings (e.g., two, three, four, five, six, seven, eight, nine, ten, or more wings).

The wing 122 is any apparatus that will move in response to a flowing fluid. For example, the wing could be in the shape of a sail, a fin, a blade, a plane, a kite, a windmill blade, a turbine blade, a flag, a bird's wing, an insect's wing, an airplane's wing, any man-made shape, any organic/natural shape, or any other such shape. In some embodiments, it is curved or substantially curved around the edges and is designed to mimic the shape of a wing of a living organism. There can be any number of wings included, and the wings can be positioned toward the top half of the shaft, toward the bottom half of the shaft, at the sides of the shaft, or any combination of these positions. The wing can be any type of manipulatable control surface. The wing 122 is made of one or more materials that are flexible, rigid, elastic or some such desirous material property, such that, while in use, the wing can undergo various combinations of twisting, warping, sweeping, camber variation, pitch angle variation, or angle of attack variation depending on the wing design. For example, the wing can be configured to change in shape (e.g., warp, twist, bend, fold, etc.) according to how fast the fluid is moving about the device 120. In this manner, the device 120 can be designed to function without breaking or otherwise being damaged in high fluid speeds. The wing can include a stiff frame member that defines the perimeter of the wing and a flexible film or material that spans the frame. The wings can also be constructed of much stiffer and more durable materials to provide long service in environments that experience frequent, strong currents. Alternatively, the wings are constructed from photovoltaic material to add solar-power generation capability. In some embodiments, where there are at least two wings, the wings are designed to absorb energy from the flow of the fluid by generating a pressure difference between the two large surfaces of the wing, similar to the way an airplane wing generates lift. In some embodiments, the wings are designed to absorb energy from the flow of fluid by obstructing the flow, similar to the way a sailboat sail absorbs energy from the wind to propel the sailboat. In some embodiments, the wings may be staggered (e.g., by positioning the devices 120 within a wind farm so that the wings are staggered across the various devices) to allow two or more proximally located devices 120 to take advantage of the vortices produced on a moving fluid by the wings. The wings can also be lined up on a long round structure (e.g., similar to a large oil pipelines structure), so the fins could produce vortices off either side of the device, and barriers could be created or placed on either side a certain distance away to destroy the vortices to prevent erosion from occurring in streams or rivers.

The wing movably attaches to the shaft 124 in some manner, or attaches to a component (e.g., a movable or rotatable component) of the shaft. In various embodiments, the wing 122 mounts through the shaft 124 (as shown in FIG. 1), around the shaft, or directly to the shaft. The wing 122 may be positioned above (as shown in FIG. 1), below, to the side of, or any position around the shaft 124. The wing 122 attaches to the shaft using collets, spring coils, bearings, pulleys, sleeves, or any such securing mechanism known to those skilled in the art. When a fluid flows past the wing, the flowing fluid induces the wing to move substantially perpendicular to the fluid flow, which causes the shaft 124 to rotate. The wing is also attached, at least in part, to the control system 128. In various embodiments, the control system 128 acts as an intermediary between the wing 122 and the shaft 124.

The size of the wing 122 can vary depending on the design. In some embodiments, the wing 122 ranges from one to ten feet in length and one half to three feet in width and has a surface area of one to sixty feet squared. In large scale applications, such as wind farms, the wing 122 may be longer than 200 feet and wider than sixty feet with a surface area of over twenty-four thousand feet squared. In addition, for each of these numerical ranges relating to wing size, the wing size can also be any range encompassed by these ranges or any values or fractional values within these ranges.

The shaft 124 is a long, rigid rod that connects to the wing 122 and the generator 126. The shaft 124 transfers the motion of the wing 122 into torque for the generator 126. In various embodiments, the shaft attaches to the base 130 (illustrated in FIG. 1). The control system 128 may attach to the shaft 124. The shaft may include a transmission, clutch, or ratcheting gears (not illustrated) to convert oscillating motion into rotational motion. In some embodiments, the shaft can also include an outer covering about the internal rod that connects to the wing and generator.

The generator 126 is any apparatus that allows the device 120 to harness torque. The generator 126 is attached to the shaft 124. In various embodiments, the generator 126 is also attached to the base 130 or forms a part of the base 130. The generator 126 can be any apparatus capable of generating electrical power, for example, an electrical generator or alternator, or any apparatus capable of pumping water. The generator 126 can also be any connector capable of attaching to any apparatus capable of generating electrical power or pumping water. The generator 126 may include transmissions, clutches, flywheels, gears, or any internal moving parts of the device 120 as well as any large housing that contains those parts. In some embodiments, the generator 126 can be contained within the base 130 or positioned elsewhere on the device 120. For example, the generator 126 can be contained within or incorporated into the shaft. The generator may contain a clutch, which will only engage the generator once in a while (e.g., for every 5th or 10th oscillation), similar to the function of a mosquito's wings. The clutch may also disengage the generator in response to a slow fluid flow in order to maintain the oscillation of the wings, or it may disengage the generator as the device is starting to allow the wings to start oscillating.

The control system 128 is any apparatus that is capable of orienting the wing 122 or coordinating the motion of the wing with the natural energy current. The control system 128 orients the wing in response to its position around the shaft 124 and a speed of the fluid flow or the speed at which the shaft rotates. The control system 128 can also reorient the wing 122 in response to drag on the wing or debris in the fluid flow. The control system is attached at least in part to the wing 122 (as illustrated in FIG. 1), and may be attached to the shaft 124, the generator 126, or the base 130 (not illustrated). In some embodiments, the control system 128 is an external system associated with the device 120. The control system can be a completely non-electronic system or can include one or more electronic components. The control system 128 may include a spring, a counterweight, a wheel and track, an air foil, or any such mechanical device. The control system 128 may reorient the wing 122 with the assistance of gravity. In some embodiments, the control system is an unstable pitch-up system that might include a counterweight or bungee. In some embodiments, the control system includes a winding mechanism associated with the axis of the device that builds tension and includes a switch to release tension, which pitches the wing in the fluid. The control system can further include a limit switch to allow the winding to switch a portion of the energy from the tension into switching the wing movement. Since the control system controls the movement of the wings, the wing movement does not have to be controlled by the weight of the wings themselves, as is the case with some existing technology.

The control system 128 can control the movement or pivoting of the wing 122 about the shaft. In some embodiments, the wing 122 oscillates back and forth about the shaft 124 in two different directions. Where there are two wings 122, the wings can oscillate back and forth about the shaft 124 in opposite directions and can be coordinated in their movement. The wing 122 can also oscillate or rotate completely about the shaft 124. Where there is more than one wing 122, the wings can rotate about the shaft 124 in a coordinated movement. Thus, pivoting about the shaft 124 can include oscillating back and forth about the shaft (without fully rotating around the shaft) or rotating around the shaft. In some embodiments, the wing 122 has a 359 degree or less range of motion about the shaft 124. In other embodiments, the wing 122 has a 360 degree range of motion about the shaft 124. In addition, the control system 128 can be a pitch control system that is configured for orienting the wing's pitch in response to gravity acting on the wing 122 and pitch control system, as well as the position of the wing and speed at which it turns around the shaft 124. The control system 128 can further rotate the wings 122 towards the shaft to decrease drag and impact forces on the wings within the fluid. In some embodiments, the control system 128 further includes a mechanism to increase lift forces acting on the wing 122 in response to the moving fluid.

The base 130 is any apparatus that is capable of supporting the device 120. In various embodiments, the base attaches to the shaft 124 or the generator 126. The base can be anchored to the ground or a structure, such as a home, building, platform, or concrete slab, or attached to a cart on a rail or track, such as a railroad track. The base 130 can be a truss, a pole, or a pole-like structure. Alternatively, the base can be a portable and/or deployable and/or retractable antenna-like device, or a hollow structure that can be weighted down with water, rocks, sand, dirt, gravel, or any other such material. The base 130 may attach to the shaft or the generator via a bearing to allow the shaft 124 to rotate in a plane substantially parallel to the ground in order that the shaft faces substantially parallel to the direction of the fluid flow. Instead of a bearing, the base 130 may be mounted to a circular track, and move about the circle in order that the shaft faces substantially parallel to the direction of the fluid flow. The track may be built around a crater. The device may be configured such that the center of mass of the device is directly over the base in order to reduce the torque on the base and bearing.

In operation, the device 120 harnesses energy contained in a fluid that flows, such as air or water. The device then converts the harnessed energy into a usable form, such as electricity that can then be used to power any desired device, or a reciprocating piston that can be used as a pump to extract water from a well or to distribute water throughout a field to irrigate crops. The wing reciprocates in a direction substantially perpendicular to the flow of the fluid through a displacement of about 90 degrees, or about 45 degrees counterclockwise from a neutral position, and about another 45 degrees clockwise from the neutral position. Thus, in operation, the wings look similar to a dragonfly's wings flapping. In other embodiments, the displacement of the wing may be greater than 90 degrees or less than 90 degrees. The device converts the reciprocating motion of the wings into rotational motion of the shaft that rotates about an axis that passes though the shaft and the generator converts the energy in the rotating shaft into an electric voltage that can be used to generate electricity.

The device pivots at least one wing about the shaft in a first direction in response to the flow of fluid about the wing. The device 120 can also be designed to pivot the wing about the shaft in a second direction in response to the flow of the fluid about the wing. The first and second direction can be the same direction or the opposition direction. This pivoting in the first and second directions drives an oscillating motion of the wing (e.g., back and forth about the shaft) or a rotating motion of the wing (e.g., around the shaft). In addition, torque is exerted on the shaft from the fluid flowing about the wing when the wing has pivoted in the first direction and torque is exerted on the shaft from the fluid flowing about the wing when the wing has pivoted in the second direction. In some embodiments, where the wing is oscillating back and forth about the shaft, the pivoting in the first direction occurs as the wing approaches a first maximum position in the oscillating motion, and the pivoting in the second direction occurs as the wing approaches a second maximum position in the oscillating motion.

In some embodiments, the pivoting can happen as the wing approaches the limit of its rotational path about the shaft. Upon reaching the limit of its rotational path about the shaft, the wing can then be moved in the opposite direction about the shaft until it again reaches the limit of its rotational path in this opposite direction. The wing can proceed with oscillating back and forth in a first direction and a second direction over time, switching direction as it reaches the limit of its oscillation. In some embodiments, the limit of the wings oscillation can be determined by the control system that controls how far the wing can oscillate. The oscillating back and forth of the wings controls the angle of attack for the wings as the move, converting natural energy currents into electricity. Where the device is designed to rotate the wings fully around the shaft, the device can pivot at least one wing about the shaft in response to a flowing fluid and torque is exerted on the shaft from the fluid flowing about the wing when the wing has pivoted about the shaft.

In various embodiments, the wing 122 is hinged where it connects to the shaft 124 (e.g., this can permit the upper half of the device 120 to pitch back). The device 120 may instead be hinged where the shaft 124 connects to the generator 126, or where the base 130 connects to either the generator 126 or the shaft 124. Alternatively, generator 126 may be broken into two parts that are connected with a hinge. The base 130 may also be broken into two parts that are connected with a hinge. The hinge allows the wing, a part of the device, or the entire device, to fold, bend, or pivot in response to debris in the fluid flow, or an increased speed of the fluid flow. A spring or some such device may be connected between the hinged portions to prevent motion in the event of no debris in the fluid flow or a low speed of the fluid flow.

The design of the device 120 provides a variety of benefits. The device 120 is a highly-efficient and reliable energy harnesser. The control system can sweep the wing back to increase reliability or it can vary pitch or control of the wing, type of warping of the wing, etc. in a way to optimize efficiency of the device 120 in harnessing energy. Some designs include a centripetal transmission to meet demands on the axis of the device 120 at higher fluid speeds. Thus, the device 120 has a variety of protections against high fluid speeds that allow it to continue to function and/or avoid damage when unexpectedly high fluid movement occurs. While most energy harnessing devices, such as windmills, start operating only in fluid (e.g., wind) speeds of at least 10 miles per hour, this device 120 will start operation and can continue to operate in fluid (e.g., wind) speeds of 2 miles per hour. In some embodiments, the device 120 will start operating in 1, 2, 3, 4, 5, 6, 7, 8, or 9 mile-per-hour moving fluids (including ranges or fractional values in between or including these numbers). Thus, it has a much lower minimal amount of natural energy currents necessary for the device to run on, and its improved reliability and resistance to damage from unpredictable weather conditions reduces cost over time. The design is more environmentally friendly than current energy harnessing devices, causing very little harm to the animals or ecosystem, and has a far greater overall energy output than existing technology, as it moves slower than windmills and utilizes cubic area/surface area to be converted into electricity. The device can also be organized in wind or water farms to maximize efficiency per square acre of land in use. The device can also be built half way underground, or mounted on an above-ground structure.

One advantage of the device 120 over existing technology is that the non-steady wing motion can exploit Stokes boundary layer effects, whereby higher lift coefficients are achievable. It takes time for a boundary layer to separate. A sufficiently rapid increase in angle of attack will inhibit boundary layer separation so that the lift coefficient can increase well beyond its steady-state maximum. This occurs when the wing chord is approximately equal to the product of the relative wind speed and the e-folding time of rate of increase in the angle of attack of the relative wind. The chord is the length from the leading edge of the wing to the trailing edge of the wing. The e-folding time is the time it takes to increase the angle of attack by a factor of e (the natural number). If the wing chord is too small, the advection time of the boundary layer vorticity over the chord of the wing is too short compared to the e-folding time, and the flow is quasi-steady.

A further advantage of exploiting a Stokes-type boundary layer is that a cruder, less expensive airfoil shape is possible. Flow separation tends to be inhibited by the rapid pitch-up of the airfoil, even with a non-optimal airfoil section.

An advantage of the purely aerodynamic control of wing pitch is that the pitching moment is proportional to the dynamic pressure of the wind. In contrast, other mechanisms for pitch control using weights or springs of constant force or strength cannot match the aerodynamic forces and moments over as wide a range of wind speeds.

The device thus harmonizes with the natural frequency of natural energy currents or resonance of a fluid. Instead of including a wing that floats through fluid, the present apparatus actually adapts to that fluid and harmonizes with it to provide maximum efficiency. The device 120 is a fluid energy device with a gravity-assisted equalizing control system. It utilizes a wing possessing a large surface area, and it can also include a counterbalance system, which synchronizes the wing position and speed with a mechanical leverage point on the body of the device 120. The outcome is a coordination and harmonization of the wing pitch angle to the natural frequency of a fluid's specific velocity. Furthermore, this device 120 is capable of adapting itself to the velocity of the surrounding fluid through a rotational sweeping control system that produces a more streamlined profile to maximize reliability.

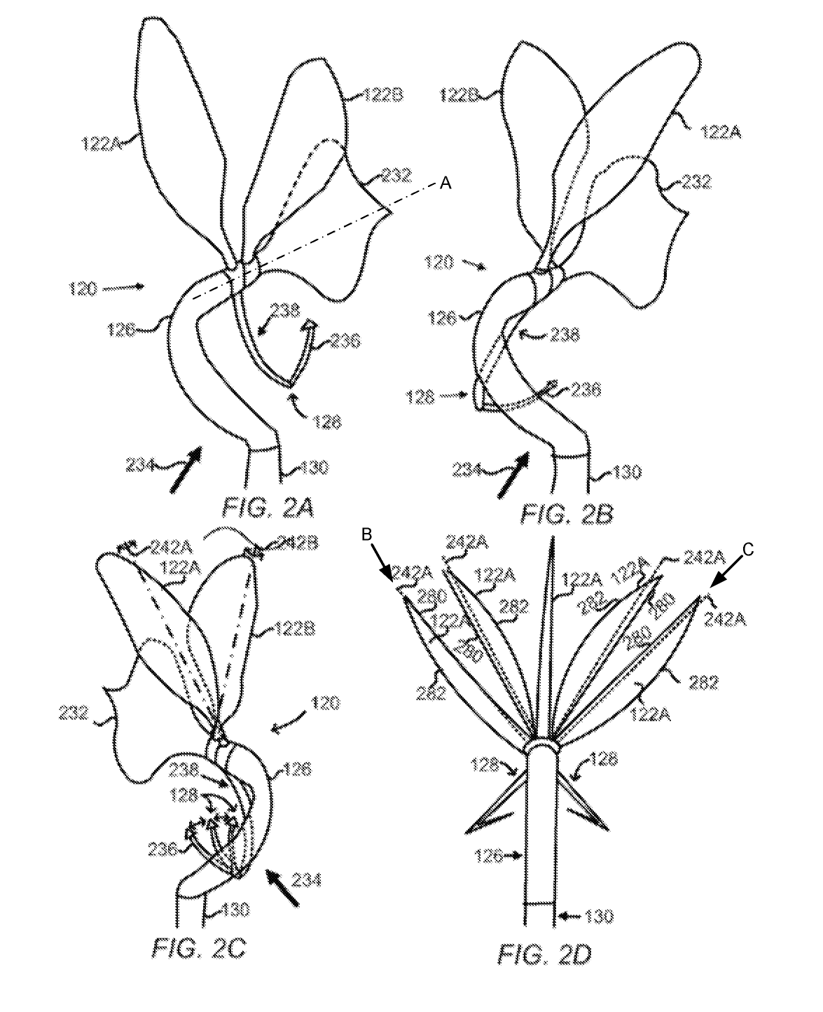

Illustrated in FIGS. 2A through 2D are various views of an embodiment of the device 120. FIG. 2A shows the embodiment of the device 120 from a front-left isometric view. The device 120 includes two wings 122, a fore wing 122A and an aft wing 122B. The fore wing 122A and aft wing 122B can be the same size and shape, or slightly different sizes and shapes to adjust the rotational torque on the base 130. The control system 128 attaches to the fore wing 122A in this embodiment. The wings 122 attach around the shaft 124 (not illustrated here). The shaft 124 rotates about shaft axis A and can connect to the generator 126, which connects to the base 130 via a rotational bearing (not illustrated). The second end of the shaft connects to a rudder 232 in this embodiment. The rudder aligns the device 120 with the direction of the fluid flow 234. Any of the embodiments described herein can include a rudder that is attached to the base, shaft, or generator (or a combination of these) and keeps the front of the device facing into the flow of the fluid. The two wings 122 oscillate back and forth through an arc about the shaft. Depending on the configuration of the control system 128, the wings 122 may oscillate synchronously. The control system 128 includes a pendulum 236 that is pivotally mounted to an arm 238.

Referring now to FIG. 2B, as the wings 122 move away from their neutral positions, the arm 238 moves away from its neutral position located directly under the generator 126. As the arm 238 moves toward a horizontal position, the weight of the pendulum 236 causes the pendulum to pivot relative to the arm 238. Referring now to FIG. 2C, when the pendulum 236 pivots through some threshold (e.g., 45 degrees), the pendulum triggers the control system 128 to rotate each of the wings 122A and 122B about its respective axis 242A and 242B.

FIG. 2D shows the change in the angle of attack of the fore wing 122A as the wing reciprocates. As the wing 122A moves counterclockwise (to the left as viewed), the wing is positioned to provide an angle of attack such that the wing's leading edge 280 is left of the axis 242A, and the wing's trailing edge 282 is right of the axis 242A. Then, when the wing 122A reaches its maximum displacement in the counterclockwise direction, the control system 128 rotates the wing about the axis 242A to change the wing's angle of attack such that the wing's leading edge 280 is now right of the axis, and the wing's trailing edge 282 is now left of the axis. With the new angle of attack, the flow of fluid across the wing 122A urges the wing to move clockwise, back toward its neutral position. Similarly, when the wing 122A reaches its maximum displacement in the clockwise direction, the control system 128 rotates the wing about the axis 242A to change the wing's angle of attack such that the wing's leading edge 280 lies to the right of the axis 242A, and the wing's trailing edge 282 lies to the left of the axis. With the new angle of attack, the flow of fluid across the wing 122A urges the wing to again move counterclockwise, back toward its neutral position.

Thus, FIGS. 2A-2D illustrate the movement of the apparatus to generate a torque from a fluid flow. With the shaft 124 rotatably coupled to a support structure, such as base 130, and oriented along a shaft axis A, at least one wing, such as 122, is rotatably coupled to the shaft 124, such that the wing 122 will impacting a fluid flow that is generally parallel to the shaft axis A. The wing 122 is oriented along a wing axis, such as axis 242A, that is substantially perpendicular to the shaft axis A.

As particularly shown in the embodiment of FIGS. 2C and 2D, the wing 122 is rotatable about the shaft 124 from a first shaft axis position (position B) to a second shaft axis position (position C), and the wing 122 rotatates about the wing axis from a first wing axis position, such as that shown at position B, to a second wing axis position, such as that shown at position C, whereby the wing 122 presents a first angle of attack for edge 280 (such as shown in FIG. 2D) when in the first wing axis position B and a second angle of attack when in the second wing axis position C. The pendulum 236 is coupled to the wing 122 and pivotable about a pendulum axis, as shown in FIG. 2C, from a first pendulum position to a second pendulum position. The pendulum 236 is configured such that when the wing 122 transitions from the first shaft axis position B to the second shaft axis position C, as shown in FIG. 2D, gravitational force causes the pendulum 236 to pivot from the first pendulum position to the second pendulum position thereby rotating the wing 122 from the first wing axis position to the second wing axis position and thereby changing the wing 122 from the first angle of attack to the second angle of attack until the wing 122 returns to the first wing axis position and first shaft axis position, or in other words, swings alternately from position B to position C. Upon a fluid flow impacting the wing 122, such as the wind, the wing 122 is rotated between the first shaft axis position B and second shaft axis position C from the pivoting of the pendulum 236 about the pendulum axis. The back and forth rotation of the wing 122 will thereby impart an alternating torque on the shaft 124 that can be mechanically directed to drive a generator 126 or pump.

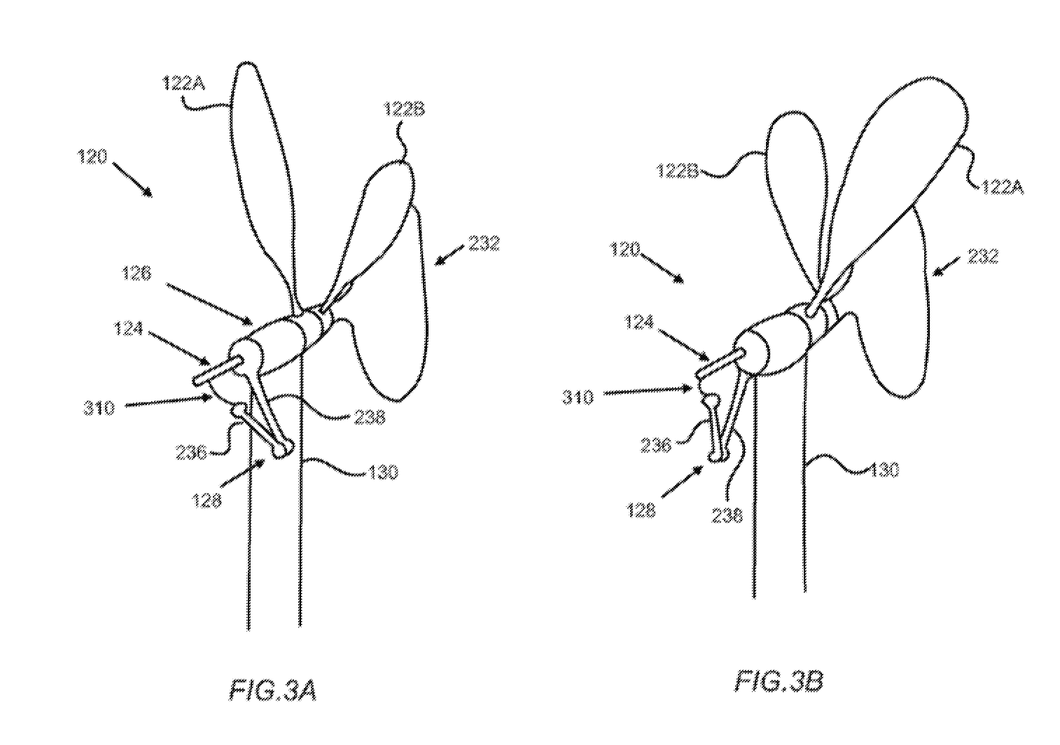

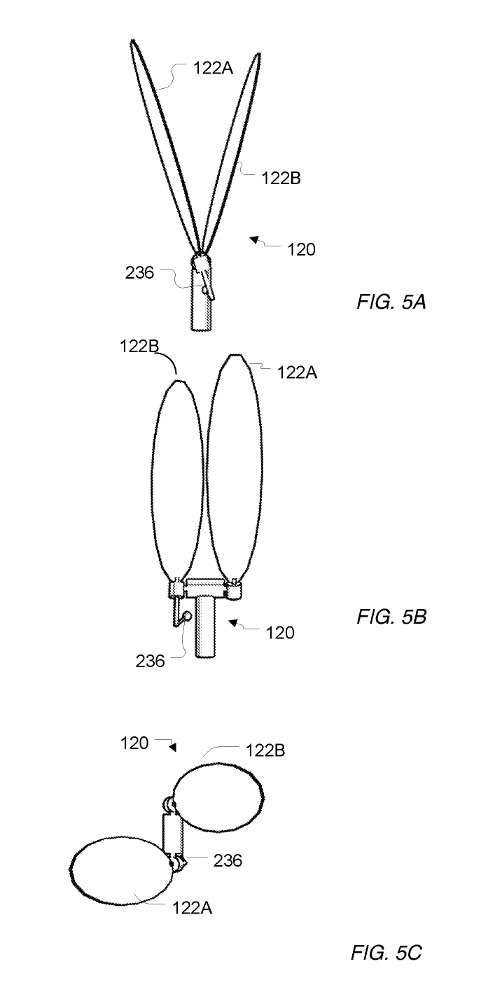

FIGS. 3A and 3B are various views the device 120, according to another embodiment of the invention. In this embodiment, the wings 122 and rudder 232 attach on one end of the shaft. The shaft 124 passes through the generator 126, and the generator attaches to the base 130. The control system 128 is attached to the shaft 124, as well as the wings 122 through an internal mechanism of the shaft (not illustrated). The control system 128 also attaches to the shaft via an elastic connector 310. The connector 310 is made of elastic, springs, bungee, nylon, or some such material. In various embodiments (see FIG. 5), the connector 310 can be positioned at any point along the pendulum 236 or arm 238 to allow different leverage properties based on the desired performance characteristics. Additionally, the connector 310 may connect to any of the shaft 124, generator 126 (not illustrated), or base 130.

Referring again to FIGS. 3A and 3B, the control system 128 is located ahead of the base 130 or upstream from the base when fluid flows across the wings 122A and 122B. This arrangement may be desirable in situations where the flow of fluid is fast so that the load on the arm 238 and pendulum 236 from the fluid flow remains substantially consistent as the arm and pendulum move between their maximum displacements. When the base 130 is located upstream from the arm 238 and pendulum 236, the base will obstruct the flow of fluid against the arm and pendulum when they are disposed behind the base. In such an embodiment, the control system 128 may be hinged so that, if the device bends back in response to debris or a high fluid flow, the control system 128 will not intersect the base 130.

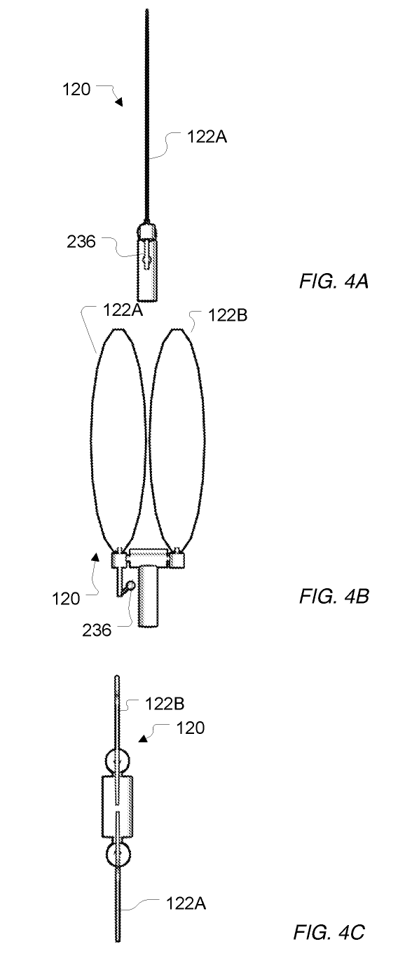

Illustrated in FIGS. 4, 5, and 6 is another embodiment of the device 120. In this embodiment, the control system 128 connects to a first end of the shaft 124 (not illustrated). The wings 122 and rudder 232 connect to a second end of the shaft 124. The control system 128 connects to the wings 122 through an internal mechanism of the shaft (not illustrated). The shaft 124 passes through the base 130, which also houses the generator 126 (not illustrated). The control system also attaches to the base via the small connector 310.

FIGS. 4A, 4B, and 4C show the device 120 with wings 122 in their neutral positions, and with the pendulum 236 directly under the arm 238. FIG. 4A illustrates a front view of the device 120. FIG. 4B illustrates a side view of the device 120. Further, FIG. 4C illustrates a top view of the device 120.

FIGS. 5A, 5B, and 5C show the device 120 with the wings about halfway to their maximum displacement away from their neutral positions, and with the pendulum 236 moved relative to its position shown in the first column. FIG. 5A shows a front view of the device 120. FIG. 5B shows a side view of the device 120. Further, FIG. 5C shows a top view of the device 120.

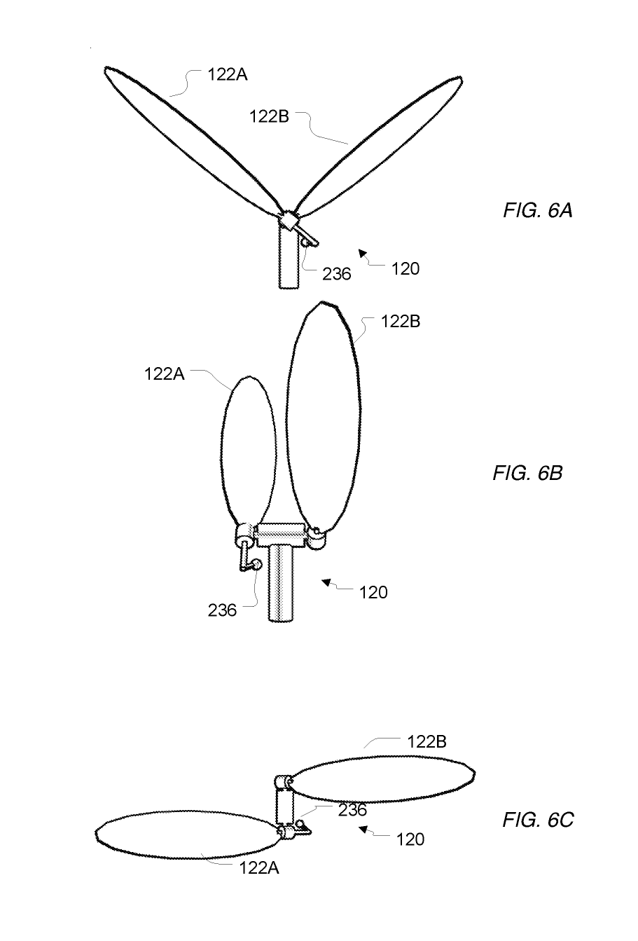

FIGS. 6A, 6B, and 6C show the device 120 with the wings 122 at about their maximum displacement away from their neutral positions, and with the pendulum 236 similarly moved relative to its position shown in FIGS. 4A, 4B, and 4C. FIG. 6A shows a front view of the device 120. FIG. 6B shows a side view of the device 120. Further, 6C shows a top view of the device 120.

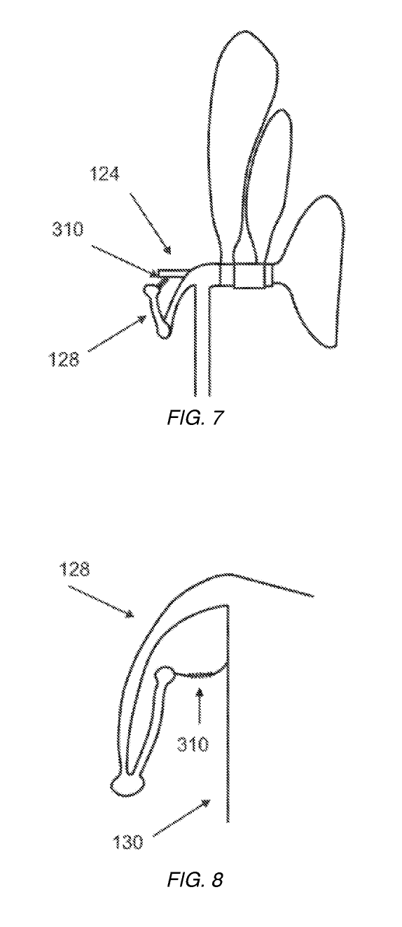

FIGS. 7 and 8 illustrated embodiments of different attachments of the control system 128. As described above, the control system 128 can attach to the shaft 124 via an elastic connector 310. FIGS. 7 and 8 illustrate how the connector 310 can be positioned at any point along the pendulum or arm to allow different leverage properties based on the desired performance characteristics. The connector 310 may also connect to any of the shaft 124, generator 126 (not illustrated), or base 130.

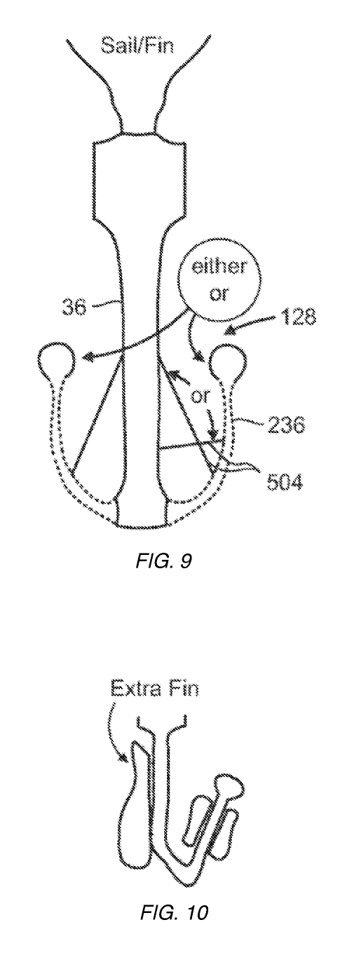

FIG. 9 illustrates a control system 128, according to one or more embodiments. In some embodiments, this control system 128 is a counterbalance or pendulum lever control arm. In some embodiments, the control system 128 includes an arm 238 and a pendulum 236. The pendulum 236 is pivotally mounted to the arm 238 and triggers the control system 128 to rotate each of the wings 122A and 122B about their respective axes to change each wing's angle of attack. In some embodiments, the arm 238 provides a counterweight to the weight of the wings 122A, 122B to balance the wings as they reciprocate between their respective maximum displacements in the clockwise and counterclockwise directions. The counterweight can be any size, length, weight, shape, or distance from the joint. The lever arm 238 can be any length, material, tensile strength, weight, angle, shape, size, ratio, material tension, or position on the counterbalance. In some embodiments, the counterweight is a reservoir or a cylinder or other container holding fluid. By providing such balance, a substantial portion of the fluid flow's energy that the wings absorb reaches the generator. Without the balance provided by the arm, the energy required to move each of the wings 122A, 122B against gravity would probably have to be provided by the energy absorbed from the flow of fluid.

In some embodiments, a bungee 504 can be included that can be composed of any given elastic material and can be used to keep the counterweight from swinging too high. The bungee 504 can also keep the system from rolling all the way around and damaging the wings 122A, 122B. The bungee 504 can be in various positions, including those shown in FIG. 9. There can be multiple bungees, as well. The bungee may also have a self-adjusting apparatus comprising a hydraulic piston, a spring, or some such device to automatically adjust the bungee's length in accordance with the force applied to the bungee by the system.

FIG. 10 illustrates a design of an extra wing or fin on the control system 128 described in FIG. 9. A system of pulleys or levers can be added to create such secondary wings or fins for added efficiency on either side of the two arms to assist with reciprocating motion in the fluid.

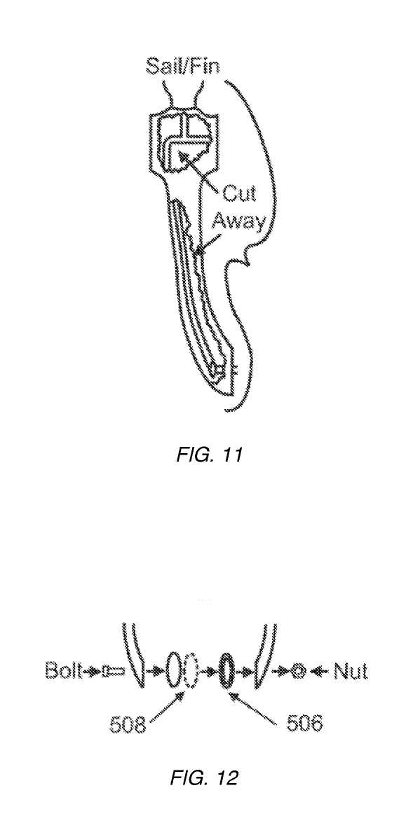

FIG. 11 illustrates a hydraulic pump or pulley 502 for use with the control system 128 as described in FIG. 9. FIG. 11 further includes including a cut-away view illustrating the internal components.

FIG. 12 illustrates a pendulum lever arm that can be positioned in front of a counterbalance arm, and leashed to the main structure to avoid over-rotation of the wings. A spring coil 506 can be included in this design, and it can be single- or double spring loaded with any given size, shape, weight, tension, or play of spring. Bearings 508 are also illustrated adjacent to the spring coil 506.

Other embodiments of the control system 128 are also possible. For example, an electronic position sensor may be used to determine when each of the wings 122A, 122B have reached their maximum displacement and thus require a change in their respective attack angles. And, an electric motor may be used to rotate the wings 122A, 122B in response to a signal from the sensor. As another example, other mechanical mechanisms may be used to trigger the control system 128, and/or rotate the wings 122A, 122B to change their attack angles. In still other examples, a computer may be used to monitor environmental conditions, such as the speed, temperature and humidity (if appropriate) of the fluid flowing across the wings, and the performance variables of the wings, such as the amount of energy absorbed from the flowing fluid relative to the total amount of energy in the fluid flow. And, in response to the environmental conditions and performance variables, the computer may modify as desired the angle of attack, as well as other variables such as maximum displacement position relative to neutral.

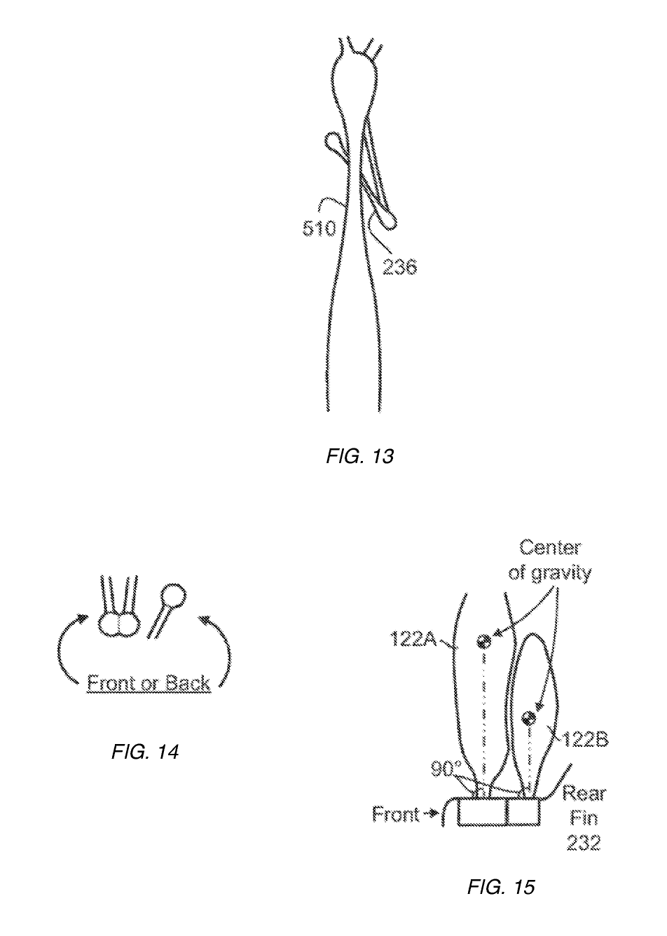

FIG. 13 illustrates a counterweight swinging past a neck of a device, such as device 120, according to one or more embodiments. The neck 510 is positioned in front of the swinging counterweights of the pendulum 236. In various embodiments, the neck 510 is designed to be as skinny as possible, while still tolerated by wind testing limits, to reduce the wobble of the weights as they pass behind the neck 510. A wind barrier could also be used to keep the wind from disrupting the movement of the counterweights in the fluid.

FIG. 14 more clearly shows the counterweights described in FIG. 13. Here the counterweights are embodied as egg-shaped to assist with aerodynamics and swinging motion.

FIG. 15 illustrates wings of the device, according to one or more embodiments. The fore wing 122A and aft wing 122B can be the same size and shape, or can be different sizes/shapes depending on the accepted limits of force and torque on the shaft. Since the aft wing 122B is further away from the pivoting point of the device and has greater leverage for keeping it facing into the wind, the aft wing 122B may be smaller, as shown in FIG. 15. The trailing edge of the wings 122A, 122B can have a control surface integrated into it, which is controlled by the same counterweight used to control the pitch of the wings and to help rotate, steer, or pitch the wings back into the fluid to assist with perpetuating the oscillating motion. Energy or work going into the trailing edge control surface of the wing coming from the counterweight lever can be spring loaded to maneuver the control surface of the wing before pitching the whole wing, to make steering the wings back into the fluid easier and more efficient.

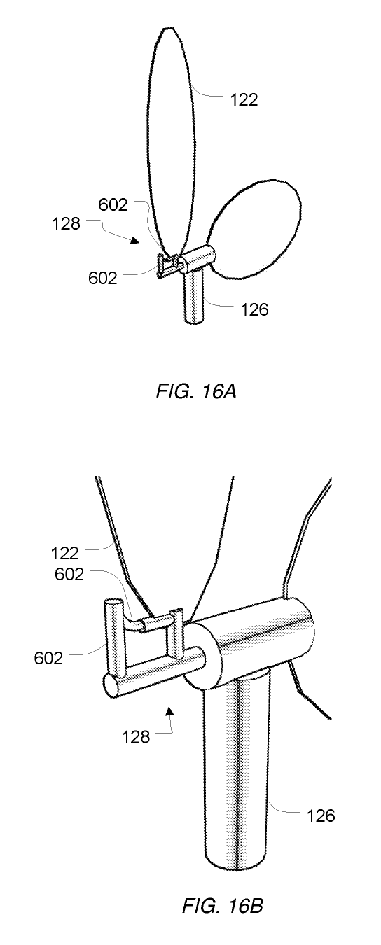

FIGS. 16A and 16B illustrate another embodiment of a control system 128 for a device, such as the device 120 shown in FIG. 1. The control system 128 comprises an arm 602 and an elastic connector 604. The arm 602 is attached to the generator 126. The elastic connector 604 connects between the arm 602 and the wing 122. The arm 602 is any structural element that can handle the stress and torque of the elastic connector 604. The elastic connector 604 is made up of a spring, bungee,

elastic, nylon, or any such material. As the wing 122 moves from the neutral position, the elastic connector 604 pulls on the wing, which rotates the wing about its axis. The flowing fluid then exerts a force on the wing, which causes it to return to and pass through the neutral position. Again, the elastic connector 604 pulls on the wing, which rotates the wing 122 the other way on its axis. The flowing fluid then exerts a force on the wing, which causes it to return to and pass through the neutral position, thereby oscillating back and forth.

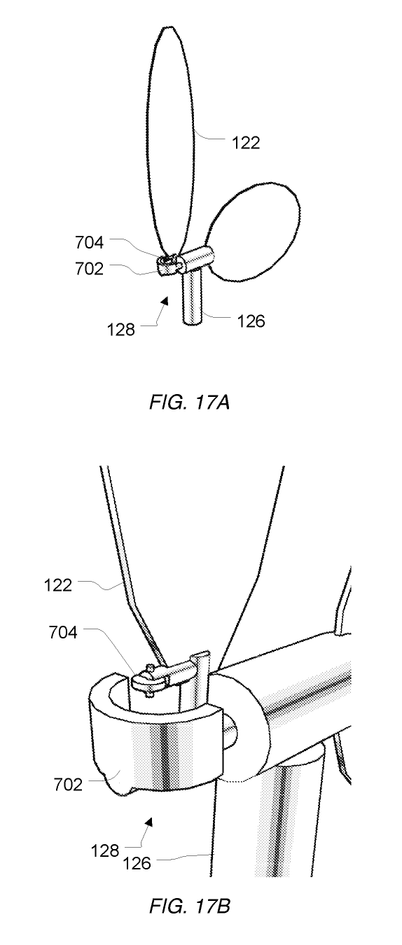

FIGS. 17A and 17B illustrate another embodiment of the control system 128 for a device, such as the device 120 shown in FIG. 1. The control system 128 comprises a U-shaped barrier 702 connected to the generator 126 and a wheel attachment 704 connected to the wing. The U-shaped barrier 702 is any U-shaped device with a groove or track or some such feature to interface with the wheel attachment 704. The U-shaped barrier 702 is attached to the generator 126. The wheel attachment 704 is an arm with a horizontal wheel. As the wing 122 moves from the neutral position, the wheel attachment 704 contacts the U-shaped barrier 702, which rotates the wing on its axis. The flowing fluid then exerts a force on the wing, which causes it to return to and pass through the neutral position. Again, wheel attachment 704 contacts the U-shaped barrier 702, which rotates the wing 122 the other way on its axis. The flowing fluid then exerts a force on the wing, which causes it to return to and pass through the neutral position, thereby oscillating back and forth.

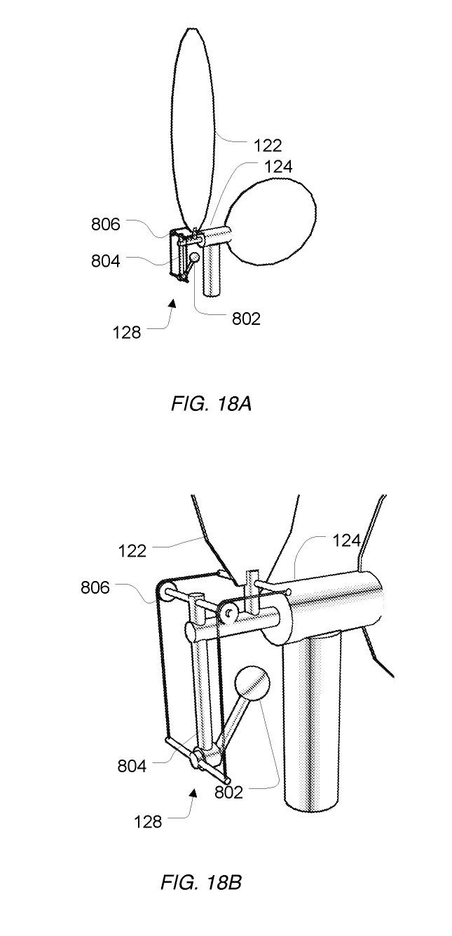

FIGS. 18A and 18B illustrate another embodiment of a control system 128 for a device, such as the device 120 shown in FIG. 1. The control system 128 comprises a pendulum 802, an arm 804, and a pulley system 806. The pendulum 802 includes a counterweight on an arm. The arm 804 connects to the shaft 124 and wing 122, as well as the pendulum 802 and pulley system 806. The pulley system 806 attaches to the pendulum 802, arm 804, and wing 122 through a system of lines and pulleys. As the wing 122 rotates from the neutral position, the arm 804 rotates the other direction. The causes the pendulum 802 to fall down, which pulls on the pulley system 806, which pulls on the wing 122, which rotates the wing on its axis. The flowing fluid then exerts a force on the wing, which causes it to return to and pass through the neutral position. Again, the pendulum 802 falls down, which pulls on the pulley system 806, which pulls on the wing 122, which rotates the wing on its axis. The flowing fluid then exerts a force on the wing 122, which causes it to return to and pass through the neutral position, thereby oscillating back and forth.

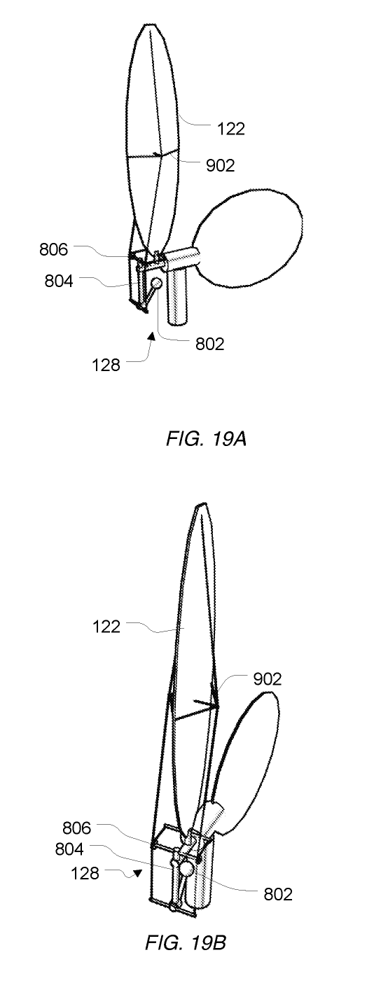

FIGS. 19A and 19B illustrate a variation of a control system 128 for a device, such as the device 120 shown in FIGS. 18A and 18B. The pulley system 806 in this embodiment has a wing attachment portion 902 that attaches in multiple places to the wing 122. As the pendulum 802 falls down, it pulls on the pulley system 806, which instead deflects the wing 122 using the wing attachment portion 902. The deflected wing 122 responds to the flowing fluid, which causes it to return to and pass through the neutral position, thereby oscillating back and forth.

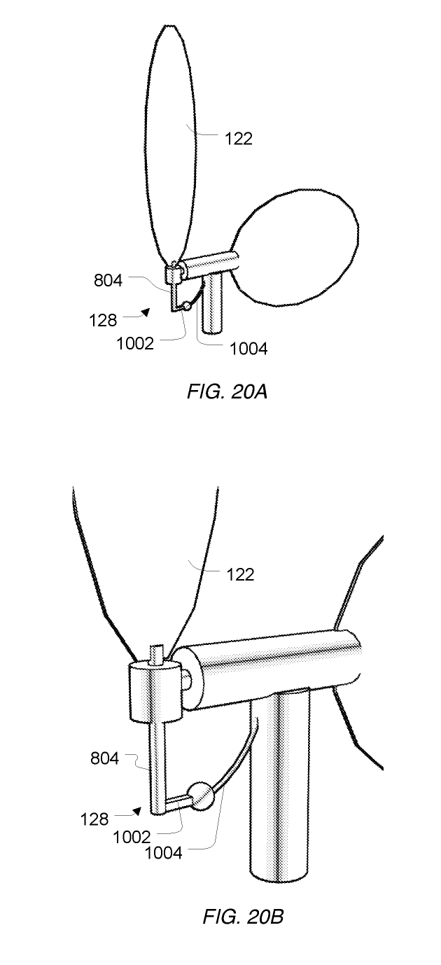

FIGS. 20A and 20B illustrate another embodiment of a control system 128 for a device, such as the device 120 shown in FIG. 1. The control system 128 comprises a pendulum 1002, and an elastic connector 1004. The pendulum 1002 is attached to the wing 122, and comprises an arm and a counterweight. The elastic connector 1004 connects between the pendulum 1002 and the wing 122. The connector 1004 is made of elastic, springs, bungee, nylon, or some such material. The connector 1004 limits the range of motion of the pendulum 1002. As the wing 122 rotates from the neutral position, the pendulum 1002 rotates the other direction. The causes the counterweight to fall down, which rotates the wing 122 on its axis. The flowing fluid then exerts a force on the wing, which causes it to return to and pass through the neutral position. Again, this causes the counterweight to fall down, which then rotates the wing 122 on its axis. The flowing fluid then exerts a force on the wing 122, which causes it to return to and pass through the neutral position, thereby oscillating back and forth.

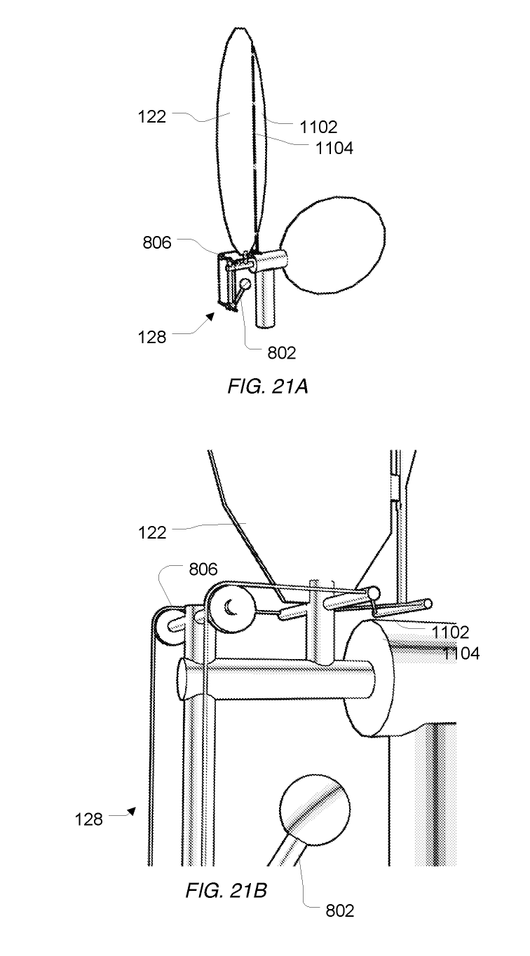

FIGS. 21A and 21B illustrate a variation of a control system 128 for a device, such as the device 120 shown in FIGS. 18A and 18B. A control surface 1102 is attached to the rear of the wing 122 via a hinge 1104. The pulley system 806 attaches to the control surface 1102. As the pendulum 802 falls down, it pulls on the pulley system 806, which instead rotates the control surface 1102 at the hinge 1104. As the wing 122 reaches the maximum extent of its oscillation, the pulley system 806 rotates the wing on its axis. The rotated wing 122 and control surface 1102 responds to the flowing fluid, which causes it to return to and pass through the neutral position. Again, the pendulum 802 falls down, pulling on the pulley system 806, which rotates the control surface 1102 and eventually rotate the wing 122 on its axis. Again, the flowing fluid exerts a force on the rotated wing 122 and control surface 1102, which causes it to return to and pass through the neutral position, thereby oscillating back and forth.

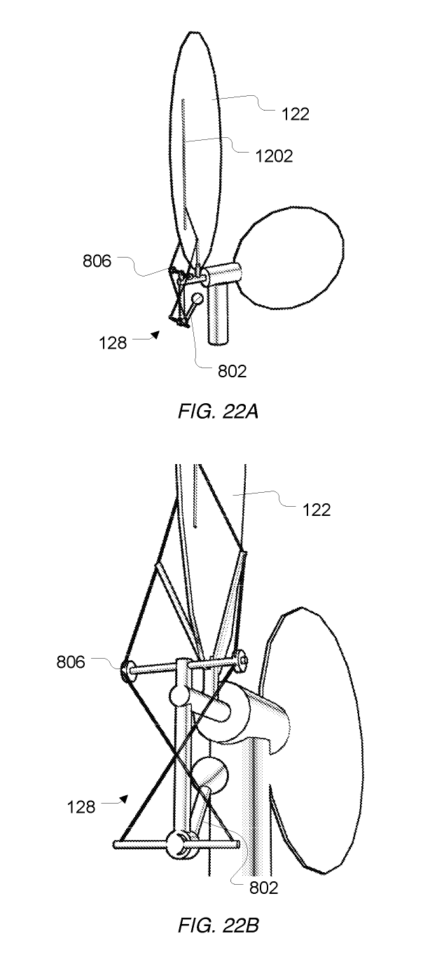

FIGS. 22A and 22B illustrate a variation of a control system 128 for a device, such as the device 120 shown in FIGS. 19A and 19B. A rigid rod 1202 is located inside of the wing 122. The wing 122 may be made up of varying materials to tune its deflections, such as fiberglass, carbon fiber, or aluminum. The pulley system connects to the rigid rod 1202 of FIGS. 22A and 22B. As the pendulum 802 falls down, it pulls on the pulley system 806, which instead pulls on the rigid rod, which causes the wing 122 to deflect. The deflected wing 122 responds to the flowing fluid, which causes it to return to and pass through the neutral position, thereby oscillating back and forth.

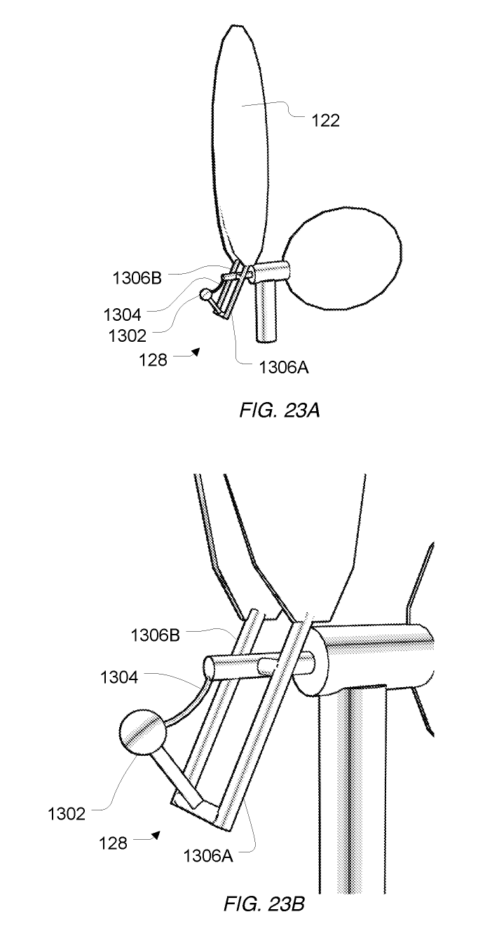

FIGS. 23A and 23B illustrate a variation of a control system 128 for a device, such as the device 120 shown in FIG. 1. The control system 128 comprises a pendulum 1302, an elastic connector 1304, and two arms 1306A and 1306B. The pendulum 1302 includes a counterweight, and connects between the two arms 1306. The elastic connector 1304 connects between the shaft 124 and the pendulum 1302. The connector 1304 is made of elastic, springs, bungee, nylon, or some such material. The two arms 1306 connect to the wing 122. As the wing 122 rotates from the neutral position, the arms 1306 rotate the other direction. This causes the pendulum 1302 to fall down, which causes the arms 1306 to scissor apart. This scissoring motion causes the wing 122 to deflect and/or rotate on its axis. The flowing fluid then exerts a force on the wing 122, which causes it to return to and pass through the neutral position. Again, the pendulum 1302 falls down, which scissors the arms 1306 and deflects and/or rotates the wing 122 on its axis. The flowing fluid then exerts a force on the wing 122, which causes it to return to and pass through the neutral position, thereby oscillating back and forth.

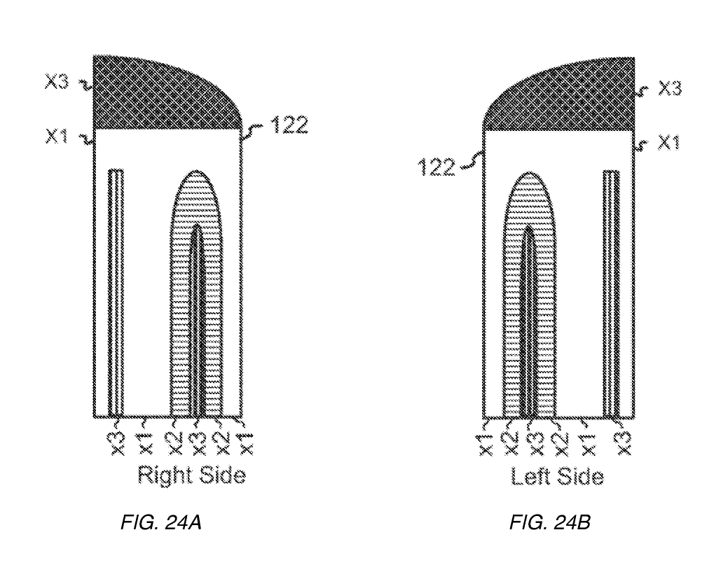

As shown in FIGS. 24A and 24B, different parts of the wing 122 can be made of different materials, such as including a more rigid material at the center of the wing (dark rod in the middle), with a somewhat less rigid material surrounding it (lined material surrounding the dark rod), and finally a less rigid material surrounding that and making up the bulk of the wing. Similarly, the tips of the wing and/or the edge of the wing can include different materials (shown as darkened areas in FIGS. 24A and 24B).

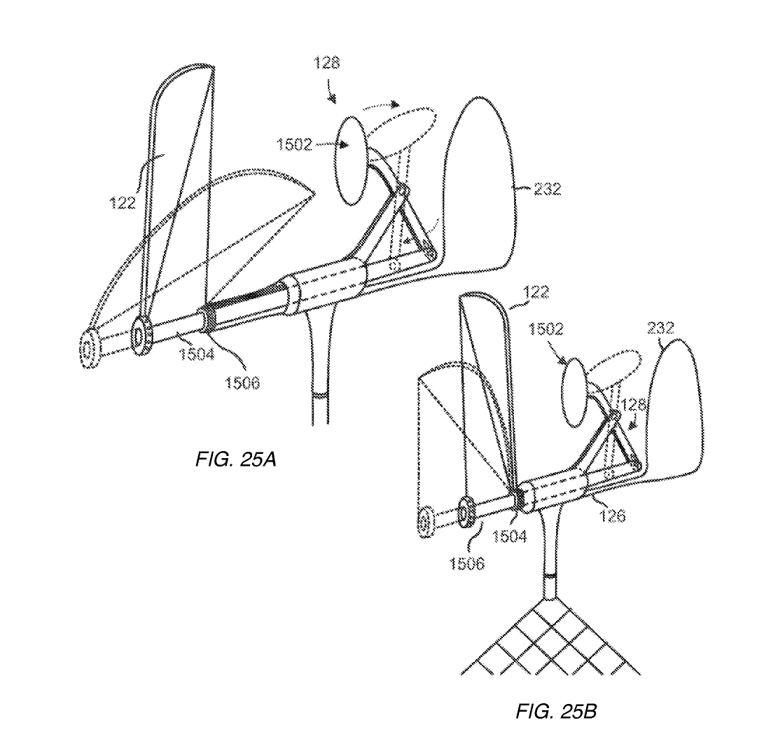

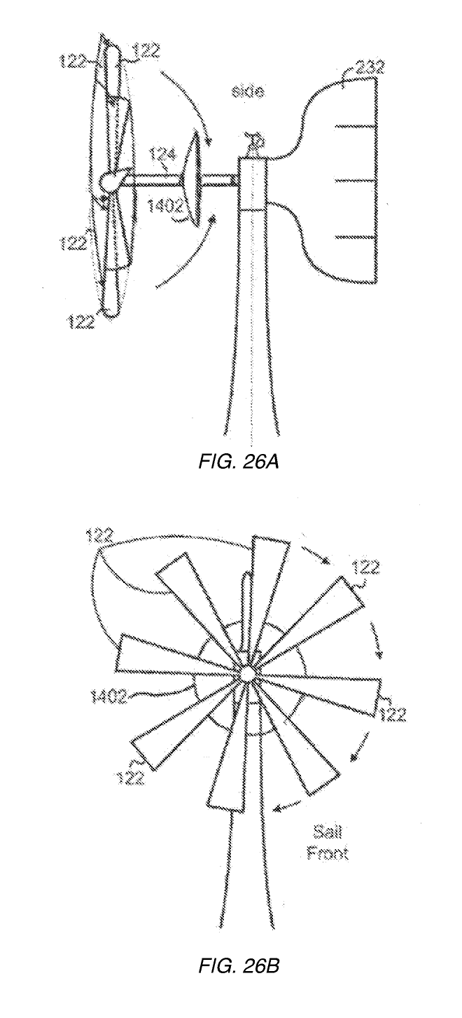

FIGS. 25A and 25B illustrate variations of a control system 128 for a device, such as the device 120 shown in FIG. 26A. For purposes of illustration, FIGS. 25A and 25B show only one wing 122, but there may be any number of wings as described with respect to FIG. 26A below. The control system 128 comprises a drag scoop 1502, a piston 1504, and a movable ring 1506. The drag scoop 1502 is a device that induces drag in order to generate substantially linear movement in response to a high speed fluid flow. The drag scoop 1502 can be any shape, and may be flat or have curvature to increase drag. The piston 1504 is a rod that translates the movement of the drag scoop 1502 to the movable ring 1506. The drag scoop 1502 attaches via a bolt or pivot to a first end of the piston 1504, and the drag scoop 1502 is attached by a bolt or pivot to the generator 126. The movable ring 1506 connects to the wings 122 via string, cord, bungee, elastic, springs, or some such mechanism. The movable ring 1506 also connects to a second end of the piston 1504. The movable ring 1506 is capable of rotating freely around the piston.

FIG. 25A shows, as the flowing fluid increases speed, the flowing fluid exerts more pressure on the drag scoop 1502, which pushes it backwards (toward the rudder 232). This causes the drag scoop 1502 to push the piston 1504 forwards (away from the rudder 232). The piston 1504 pushes the movable ring 1506 forward, which both pushes the wing away from the rudder 232 and pulls the connecting string into the shaft 124, which causes the wings 122 to fold towards the shaft. As the flowing fluid decreases speed, the flowing fluid exerts less pressure on the drag scoop 1502, and the drag scoop slides forward, which moves the piston 1504 backwards. This moves the movable ring 1506 backwards, which allows the base of the wings to move towards the rudder and the connecting string to release from the shaft, and the wings 122 to return to their neutral position. The motion of the drag scoop 1502 and piston 1504 may be aided by a spring, bungee, elastic, nylon, or another such material (not shown).

FIG. 25B shows, as the flowing fluid increases speed, the flowing fluid exerting more pressure on the drag scoop 1502, which pushes it backwards (toward the rudder 232). This causes the drag scoop 1502 to push the piston 1504 forwards (away from the rudder 232). The piston 1504 pushes the movable ring 1506 forward, which pulls the connecting string forward, which folds the wings 122 towards the shaft. As the flowing fluid decreases speed, the flowing fluid exerts less pressure on the drag scoop 1502, and the drag scoop slides forward, which moves the piston 1504 backwards. This moves the movable ring 1506 backwards, which allows the connecting string to relax backwards, allowing the wings 122 to return to their neutral position. The motion of the drag scoop 1502 and piston 1504 may be aided by a spring, bungee, elastic, nylon, or another such material (not shown).

FIGS. 26A and 26B are various views of a further embodiment of a device, such as the device 120 shown in FIG. 1. FIG. 26A shows a side view of the device 120. The device comprises a plurality of wings 122, which attach to the shaft 124 and rotate in either a clockwise (as illustrated in FIG. 26B) or counterclockwise direction. The wings 122 may be hinged where they mount to the shaft 124 in order to support the actions of the control system 128. The device 120 can includes a rudder 232 as described above in reference to FIG. 2A. FIG. 26B illustrates a front view of the device in FIG. 26A.

FIG. 26A further illustrates the control system 128 comprising a drag scoop 1402 connected to the wings 122 via string, cord, bungee, elastic, springs, or some such mechanism. The drag scoop 1402 mounts around shaft 124 and moves freely along the shaft. The drag scoop 1402 is a device that creates drag in order to generate substantially linear movement. The drag scoop 1402 can be any shape, and may be flat or have curvature to increase drag (see drag scoop 1402 shown by itself to the right of the device, as one example). As the flowing fluid increases speed, the flowing fluid exerts more pressure on the drag scoop 1402, which pushes it backwards along the shaft 124. As the drag scoop 1402 moves backwards (e.g., toward the rudder 232), it pulls on the wings 122, which causes them to fold down towards the shaft 124. As the flowing fluid decreases speed, the flowing fluid exerts less pressure on the drag scoop 1402, and the drag scoop slides forward along the shaft 124. This allows the wings 122 to return to their normal upright position.

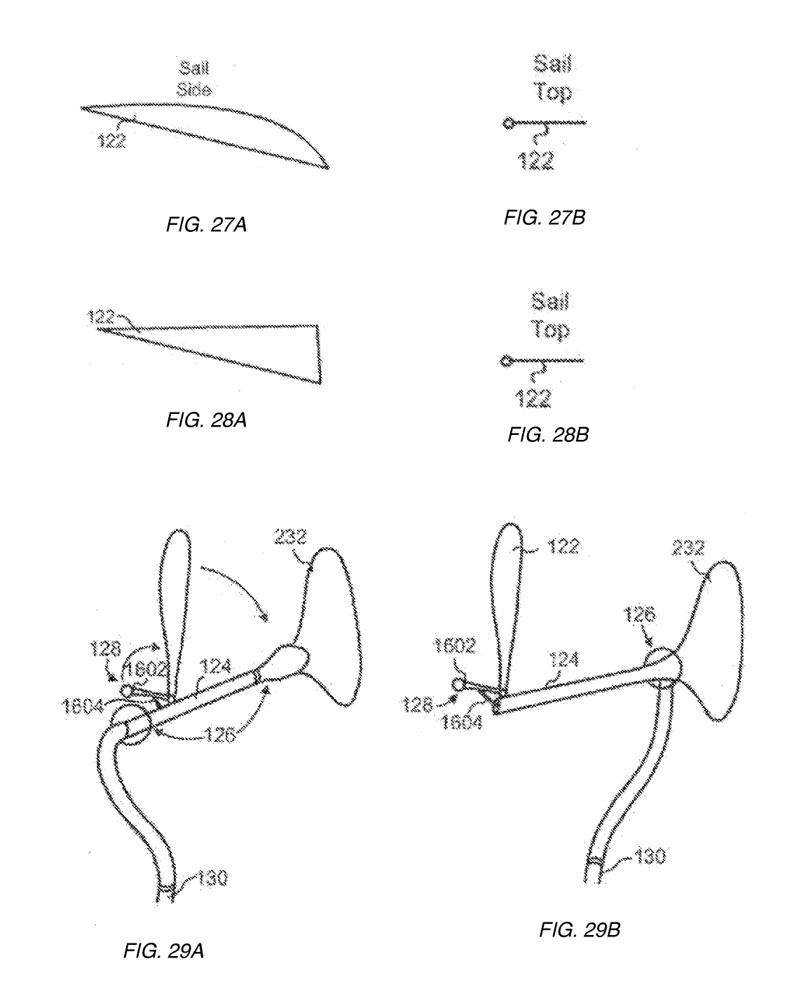

As illustrated in FIGS. 27A, 27B, 28A, and 28B, the wings 122 may be of any number, size, or shape, as long as the center of gravity of the wings is substantially at the axis of rotation. FIGS. 27A and 27B illustrate one embodiment of a curved wing in a sail-shape, and FIGS. 28A and 28B illustrate one embodiment of the wing in a triangular shape.

FIGS. 29A and 29B illustrate variations of a control system 128 for a device, such as the device 120 shown in FIG. 26A. For purposes of illustration, FIGS. 29A and 29B show only one wing 122, but there may be any number of wings as described with respect to FIG. 26A above. The control system 128 comprises a weighted arm 1602 and an elastic connector 1604 for each wing 122. The weighted arm 1602 includes a weight attached to a long lever arm. The weighted arm 1602 connects to the wing 122. The connector 1604 is made of elastic, springs, bungee, nylon, or some such material. The elastic connector 1604 connects between the shaft 124 and the weighted arm 1602. FIGS. 29A and 29B also show a generator 126 being located along the shaft 124. In FIG. 29A, the generator 126 can be located at either of the positions shown (or there can be two generators, one at each position) at the front of the device before the wing 122 or at the back of the device near the rudder 232.

FIG. 29A shows, as the flowing fluid increases speed, the wings 122 rotate faster around the shaft 124. Through the effects of centrifugal force, the weighted arm 1602 rises farther away from the shaft 124. Since the arm 1602 and the wing 122 are connected, the rising of the arm causes the wing to fold back towards the shaft 124. As the flowing fluid decreases speed, the wings 122 rotate slower around the shaft 124. This allows the weighted arms 1602 to return to their neutral position next to the shaft 124, which allows the wings 122 to return to their upright neutral position. The motion of the weighted arm 1602 is assisted by the connector 1604 by the connector pulling the arm back towards the shaft.

FIG. 29B shows the control system 128 of FIG. 29A located in a different location along the shaft. The control system 128 may be located in front of or behind the base 130.

In various embodiments, the control system 128 illustrated in FIGS. 29A and 29B may contain fewer than one weighted arm 1602 and elastic connector 1604 for each wing 122. The control system may instead use a system of string and pulleys, or gears, or similar such device, to transfer the motion of one weighted arm 1602 to multiple wings 122.

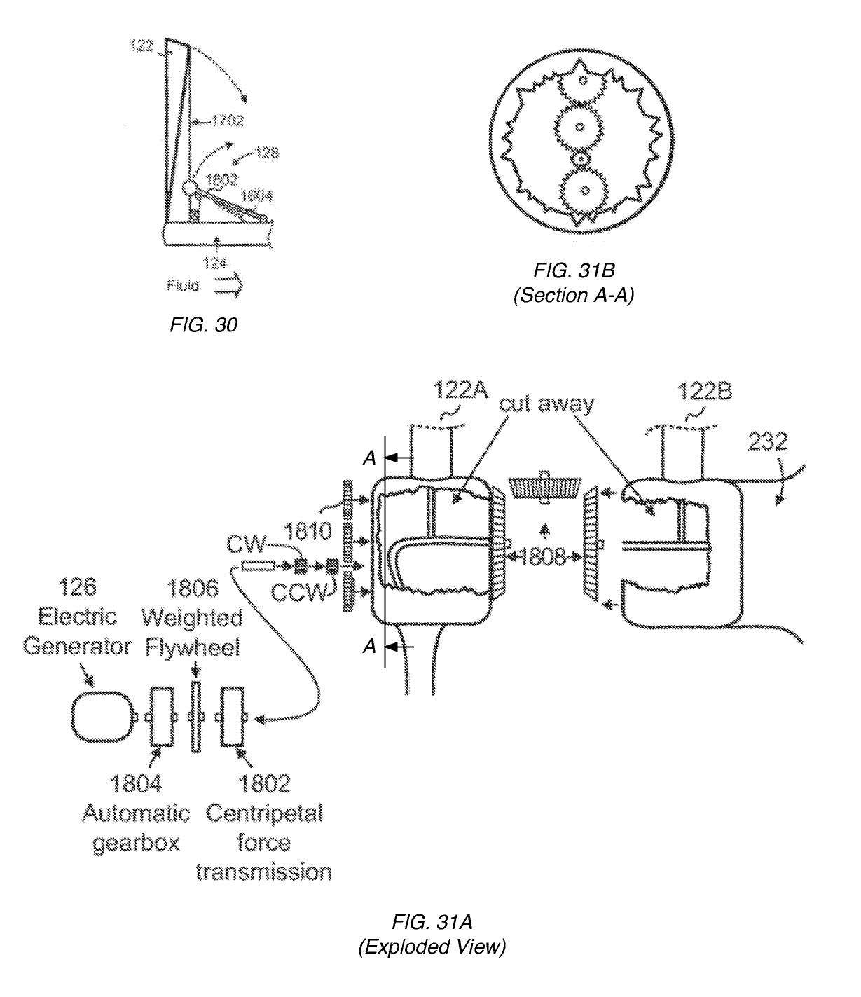

FIG. 30 illustrates a variation of a control system 128 for a device, such as the device 120 shown in FIGS. 29A and 29B. For purposes of illustration, FIG. 30 shows only one wing 122, but there may be any number of wings as described with respect to FIG. 29A above. The control system 128 retains the weighted arm 1602 and connector 1604, and ads a pulley system 1702. The pulley system 1702 comprises string, cord, rope, chain, or some such connector and one or more pulleys. The arm 1602 is connected to the shaft 124 via a hinge, bolt, pivot, or some such device, and the pulley system 1702 connects the weighted arm to the wing 122. Through the effects of centrifugal force, the weighted arm 1602 rises farther away from the shaft 124. The pulley system 1702 translates this motion to the wing 122, which causes the wing to fold back towards the shaft 124. As the flowing fluid decreases speed, the wings 122 rotate slower around the shaft 124. The allows the weighted arms 1602 to return to their neutral position next to the shaft 124, which allows the wings 122 to return to their upright neutral position. The motion of the weighted arm 1602 is assisted by the connector 1604 pulling the arm back towards the shaft.

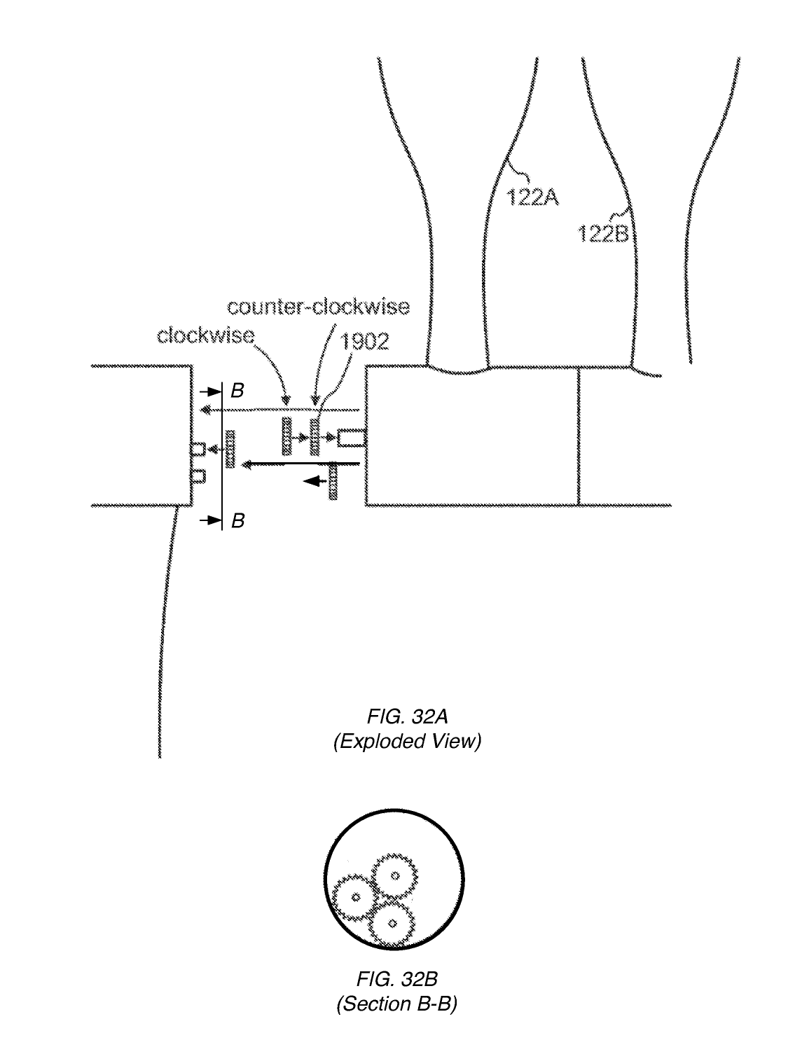

FIGS. 31A and 32A illustrate exploded views of internal mechanisms that can be included in the device, such as in device 120 in FIG. 1, according to one or more embodiments of the invention. The internal mechanisms shown in FIGS. 31A and 32A provide examples of a gearing system and transmission that the system can incorporate to convert the reciprocating motion of the wings 122A and 122B into a non-reciprocating motion, such as rotation of shaft in a single direction, clockwise or counterclockwise. As discussed above, the device can also include a generator 126, such as an electric generator illustrated in FIG. 31A, which can be coupled to the transmission to generate an electric voltage that can be used to generate electricity. The designs shown in FIGS. 31A and 32A can be included or used with any of the embodiments described herein.

FIG. 31A illustrates the generator 126 connecting to an automatic gearbox 1804, which connects to a weighted flywheel 1806 that then connects to the centripetal force transmission 1802. The components attach to the rest of the device via a set of ratcheting gears 1810 (see also FIG. 31B), and transmit through the shaft to the fore wing 122A and the aft wing 122B via gears 1808 that are positioned at the shaft between the two wings 122A and 122B. The rear rudder 232 is shown to the right of FIG. 31A. The counterbalance, pendulum, or other control arm can be mounted below the fore wing 122A, as shown in FIG. 31A. A reverse rotating gearbox system or other similar device, such as a differential, can be included to make the fore wing 122A and aft wing 122B rotate synchronously in opposite directions related to the structure on which they are mounted and to the rear rudder 232.

FIG. 32A illustrates converting reciprocating to unidirectional rotation (e.g., two one-way clutches), including illustrating freewheel mechanism ratcheting gears 1902 that can turn clockwise or counterclockwise to operate the device. FIG. 32B illustrates a cross-sectional view through section B-B of FIG. 32A, and depicts one embodiment of the arrangement of the ratcheting gears.

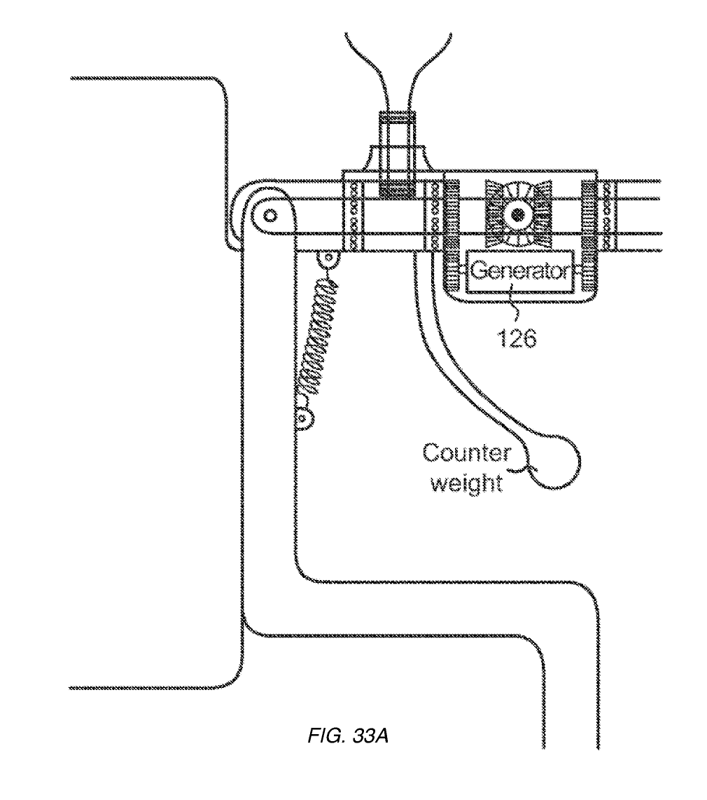

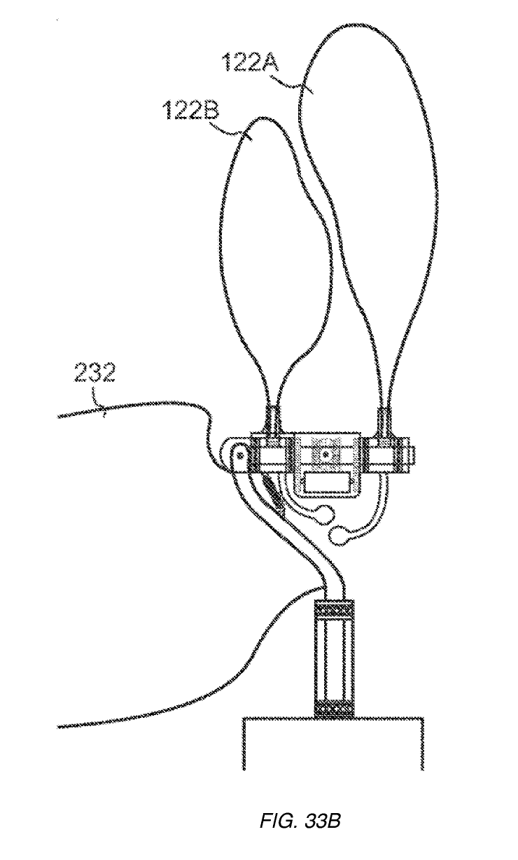

FIGS. 33A and 33B illustrate internal components a device, such as device 120, according to one or more embodiments of the invention. FIG. 33B shows a larger view, also illustrating the wings 122A and 122B, along with the rudder 232. FIG. 33A shows a close-up view of the internal components of the device. In this embodiment, the generator 126 is included below the shaft, which is one example of a positioning for the generator. However, the generator can be positioned at various other locations on the device. FIG. 33B illustrates how the rudder 232 can attach along the length of the base structure on which the device rests.

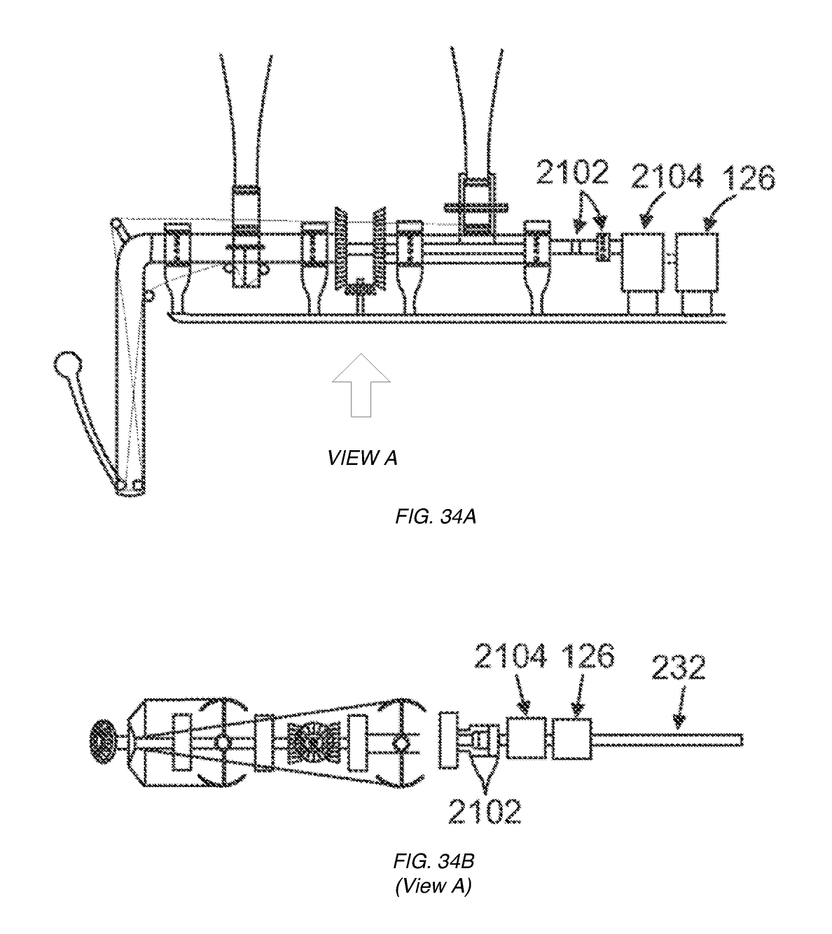

FIGS. 34A and 34B illustrates internal components of the shaft of a device, according to one or more embodiments of the invention. In this embodiment, the device can include two generators 126 that are positioned at the shaft of the device. Any number of additional generators can also be included. The device also includes a gearbox 2104 and clutch bearings 2102.

The present invention has been described in particular detail with respect to several possible embodiments. Those of skill in the art will appreciate that the invention may be practiced in other embodiments.

What is claimed is:

1. An apparatus for generating a torque from a fluid flow, comprising:
a shaft rotatably coupled to a support structure and oriented along a shaft axis;
at least one wing rotatably coupled to the shaft, the wing for impacting a fluid flow that is generally parallel to the shaft axis,
the wing oriented along a wing axis that is substantially perpendicular to the shaft axis, and
the wing rotatable about the shaft from a first shaft axis position to a second shaft axis position, and
the wing rotatable about the wing axis from a first wing axis position to a second wing axis position such that the wing presents a first angle of attack when in the first wing axis position and a second angle of attack when in the second wing axis position;
a pendulum coupled to the wing and pivotable about a pendulum axis from a first pendulum position to a second pendulum position, the pendulum configured such that when the wing transitions from the first shaft axis position to the second shaft axis position, gravitational force causes the pendulum to pivot from the first pendulum position to the second pendulum position thereby rotating the wing from the first wing axis position to the second wing axis position and thereby changing the wing from the first angle of attack to the second angle of attack until the wing returns to the first wing axis position and first shaft axis position; and
wherein upon a fluid flow impacting the wing, the wing being rotated between the first shaft axis position and second shaft axis position from the pivoting of the pendulum about the pendulum axis to thereby impart torque on the shaft.

2. The apparatus of claim 1, further comprising a spring coupled to the pendulum and positioned about the pendulum axis to resist motion of the pendulum about the pendulum axis.

3. The apparatus of claim 1, further comprising:
a second wing coupled to the shaft, the second wing oriented along a second wing axis that is substantially perpendicular to the shaft axis, the second wing further rotatable about the shaft from a third shaft axis position to a fourth shaft axis position, and the second wing further rotatable about the second wing axis from a third wing axis position to a fourth wing axis position such that the second wing presents a first angle of attack when in the third wing axis position and a second angle of attack when in the fourth wing axis position; and
a second pendulum coupled to the second wing and pivotable about a second pendulum axis from a first second pendulum position to a second second pendulum position, the second pendulum configured such that when the second wing transitions from the third shaft axis position to the fourth shaft axis position, gravitational force causes the second pendulum to pivot from the first second pendulum position to the second second pendulum position thereby rotating the second wing from the third wing axis position to the fourth wing axis position and thereby changing the second wing from the first second wing angle of attack to the second second wing angle of attack until the second wing returns to the third wing axis position and third shaft axis position; and
wherein upon a fluid flow impacting the second wing, the wing being rotated between the third shaft axis position and fourth shaft axis position from the pivoting of the second pendulum about the second pendulum axis to thereby impart torque on the shaft.

4. The apparatus of claim 1, further comprising a rudder that defines a plane such that a normal to the plane is substantially perpendicular to the shaft axis, wherein the fluid flow impacting the rudder rotates the shaft such that the fluid flow is maintained in substantial parallel alignment with the shaft axis.

5. The apparatus of claim 1, wherein:
the wing defines a leading edge and a trailing edge, such that
when the wing is in the first wing axis position, the trailing edge is on a first side of the wing axis, and
when the wing is in the second wing axis position, the trailing edge is on a second side of the wing axis opposite the first side of the wing axis.

6. An apparatus for generating a torque from a fluid flow, comprising:
a shaft means rotatably coupled to a support structure oriented along a shaft axis, the shaft means for supporting at least one wing means;
at least one wing means rotatably coupled to the shaft, the wing means for impacting a fluid flow that is generally parallel to the shaft axis,
the wing means oriented along a wing axis that is substantially perpendicular to the shaft axis, and
the wing means rotatable about the shaft from a first shaft axis position to a second shaft axis position, and
the wing means rotatable about the wing axis from a first wing axis position to a second wing axis position such that the wing means presents a first angle of attack when in the first wing axis position and a second angle of attack when in the second wing axis position;
a pendulum means coupled to the wing and pivotable about a pendulum axis from a first pendulum position to a second pendulum position, the pendulum means for pivoting from the first pendulum position to the second pendulum based upon gravitational force thereby rotating the wing means from the first wing axis position to the second wing axis position and thereby changing the wing means from the first angle of attack to the second angle of attack until the wing returns to the first wing axis position; and
wherein upon a fluid flow impacting the wing means, the wing means further for rotating between the first shaft axis position and second shaft axis position from the pivoting of the pendulum means about the pendulum axis to thereby impart torque on the shaft means.

7. The apparatus of claim 6, further comprising a spring means coupled to the pendulum and positioned about the pendulum axis for resisting motion of the pendulum mean about the pendulum axis.

8. The apparatus of claim 6, further comprising:
a second wing means coupled to the shaft means, the second wing means oriented along a second wing axis that is substantially perpendicular to the shaft axis, the second wing means for rotatating about the shaft from a third shaft axis position to a fourth shaft axis position, and the second wing further for rotating about the second wing axis from a third wing axis position to a fourth wing axis position such that the second wing means presents a first angle of attack when in the third wing axis position and a second angle of attack when in the fourth wing axis position; and
a second pendulum means coupled to the second wing means and for pivoting about a second pendulum axis from a first second pendulum position to a second second pendulum position, the second pendulum means for pivoting from the first second pendulum position to the second second pendulum position thereby rotating the second wing means from the third wing axis position to the fourth wing axis position and thereby changing the second wing means from the first second wing angle of attack to the second second wing angle of attack until the second wing returns to the third wing axis position and third shaft axis position; and
wherein upon a fluid flow impacting the second wing means, the second wing means further for rotating between the third shaft axis position and fourth shaft axis position from the pivoting of the second pendulum means about the second pendulum axis to thereby impart torque on the shaft means.

9. The apparatus of claim 6, further comprising a rudder means for rotating the shaft means such that the fluid flow is maintained in substantial parallel alignment with the shaft axis, the rudder means further defining a plane such that a normal to the plane is substantially perpendicular to the shaft axis such that the fluid flow impacting the rudder means rotates the shaft means.

10. An apparatus for generating a torque from a moving fluid, comprising:
a shaft oriented along a shaft axis;
at least one wing coupled to the shaft,
the wing is oriented along a wing axis that is substantially perpendicular to the shaft axis, and the wing is rotatable about the shaft from a first shaft axis position to a second shaft axis position such that the wing is rotatable about the wing axis from a first wing axis position to a second wing axis position wherein the wing presents a first angle of attack when in the first wing axis position and a second angle of attack when in the second wing axis position; and
a pendulum pivotable about a pendulum axis from a first pendulum position to a second pendulum position, wherein the pendulum is mechanically coupled to the wing such that when the pendulum transitions from the first pendulum position to the second pendulum position, the wing correspondingly transitions from the first wing axis position to the second wing axis position.

11. The apparatus of claim 10, wherein the pendulum axis is substantially parallel to the shaft axis.

12. The apparatus of claim 11, wherein the pendulum axis is positioned opposite the wing relative to the shaft axis, and wherein the pendulum extends towards the shaft axis.

13. The apparatus of claim 10, further comprising a spring coupled to the pendulum and positioned about the pendulum axis to resist motion of the pendulum about the pendulum axis.

14. The apparatus of claim 10, further comprising a connector coupled to the pendulum and at least one additional component of the apparatus, the connector limiting the range of motion of the pendulum.

15. The apparatus of claim 10, further comprising:
a second wing coupled to the shaft, the second wing oriented along a second wing axis that is substantially perpendicular to the shaft axis, the second wing further rotatable about the shaft from a third shaft axis position to a fourth shaft axis position, and the second wing further rotatable about the second wing axis from a third wing axis position to a second wing axis position such that the wing presents a first angle of attack when in the first wing axis position and a second angle of attack when in the second wing axis position; and
a second pendulum pivotable about a second pendulum axis from a third pendulum position to a fourth pendulum position, the second pendulum mechanically coupled to the second wing such that when the second pendulum transitions from the first pendulum position to the second pendulum position, the second wing correspondingly transitions from the third wing axis position to the fourth wing axis position.

16. The apparatus of claim 15, wherein the second wing has a surface area smaller than a surface area of the wing.

17. The apparatus of claim 10, wherein the pendulum is mechanically coupled to the wing such that when the pendulum transitions from the second pendulum position to the first pendulum position, the wing correspondingly transitions from the second wing axis position to the first wing axis position.

18. The apparatus of claim 10, wherein the wing is hinged to the shaft.

19. The apparatus of claim 10, further comprising a rudder that defines a plane such that a normal to the plane is substantially perpendicular to the shaft axis.

20. The apparatus of claim 10, wherein:
the wing defines a leading edge and a trailing edge, such that
when the wing is in the first wing axis position, the trailing edge is on a first side of the wing axis, and
when the wing is in the second wing axis position, the trailing edge is on a second side of the wing axis opposite the first side of the wing axis.
